(19) United States
(12) Patent Application Publication
(10) Pub. No.: US 2025/0180867 A1
(43) Pub. Date: Jun. 5, 2025

(54) IMAGING LENS, IMAGING DEVICE, AND INFORMATION PROCESSING APPARATUS

(71) Applicant: Lenovo (Singapore) Pte. Ltd., Singapore (SG)

(72) Inventors: Takashi Kubota, Kanagawa (JP); Koji Kawakita, Kanagawa (JP)

(73) Assignee: Lenovo (Singapore) Pte. Ltd., Singapore (SG)

(21) Appl. No.: 18/938,756

(22) Filed: Nov. 6, 2024

(30) Foreign Application Priority Data
Nov. 30, 2023 (JP) 2023-202921

(51) Int. Cl. G02B 13/00; G02B 9/34; H04N 23/55

(52) U.S. Cl. CPC G02B 13/004; G02B 9/34; H04N 23/55

(57) ABSTRACT

An imaging lens includes: a first lens to a fourth lens disposed in order from an object side; and an aperture stop on a foremost object side. The first lens is a positive meniscus lens having a convex surface facing the object side. The second lens is a lens having an inflection point on at least one surface with a low thickness deviation ratio. The third lens is a positive lens having a convex surface facing an image plane side and an inflection point on a lens peripheral portion. The fourth lens is a negative lens having a concave surface on an image plane side and an inflection point on a peripheral portion.

### CROSS-REFERENCE TO RELATED APPLICATIONS

This application claims priority to Japanese Patent Application No. 2023-202921 filed on Nov. 30, 2023, the contents of which are hereby incorporated herein by reference in their entirety.

### TECHNICAL FIELD

The present disclosure relates to an imaging lens, an imaging device, and an information processing apparatus.

### BACKGROUND

In recent years, imaging devices such as digital still cameras, digital camcorders, and smartphone cameras, which include solid-state imaging elements such as charge coupled devices (CCD) or complementary metal oxide semiconductors (CMOS) and imaging lenses, have become widespread.

The solid-state imaging element used in these imaging devices is increased in the number of pixels. With the increase in the number of pixels of the solid-state imaging element, the imaging lens is also required to have higher optical performance.

In addition, in recent years, in the personal computer (PC) provided with the imaging device, video distribution or communication is performed via the Web. Therefore, the imaging device is also being miniaturized in consideration of portability. The imaging device required in the market is mainly a device that achieves both high performance and miniaturization, and not only high performance but also miniaturization is required for the imaging lens. Therefore, an imaging lens that achieves both high performance and miniaturization is known (refer to, for example, Japanese Unexamined Patent Application Publication (Translation of PCT Application) No. 2017-513034 and Japanese Unexamined Patent Application Publication No. 2015-106155).

Incidentally, in recent years, in a case where video distribution or communication is performed via the Web, there has been a demand for an imaging lens that can image with a wider angle of view than that of the imaging lens in the related art. Therefore, there has been a demand for a bright, high-performance, and small imaging lens with a wider angle of view than the imaging lens in the related art.

### SUMMARY

One or more embodiments of the present disclosure provide a bright, high-performance, and small imaging lens with a wide angle of view, an imaging device, and an information processing apparatus.

According to one or more embodiments of the present disclosure, there is provided an imaging lens including a first lens to a fourth lens disposed in order from an object side, and an aperture stop on a foremost object side, in which the first lens is a positive meniscus lens having a convex surface facing the object side, the second lens is a lens having an inflection point on at least one surface with a low thickness deviation ratio, the third lens is a positive lens having a convex surface facing an image plane side and an inflection point on a lens peripheral portion, the fourth lens is a negative lens having a concave surface on an image plane side and an inflection point on a peripheral portion, and Conditions (1) and (2) are satisfied, 0.45<|f/f1|<0.80 . . . (1) and 0.25<|f4/f1|<0.50 . . . (2), when a focal length of the first lens is denoted by f1, a focal length of the fourth lens is denoted by f4, and a focal length of an entire optical system is denoted by f.

In addition, according to a second aspect of the present disclosure, there is provided an imaging device including the imaging lens described above, and a solid-state imaging element configured to receive an image formed by the imaging lens and generate an imaging signal.

In addition, according to a third aspect of the present disclosure, there is provided an information processing apparatus including the imaging device described above, and a display unit configured to display an image corresponding to the imaging signal generated by the imaging device.

According to the present disclosure, it is possible to provide an advantageous effect of providing a bright, high-performance, and small imaging lens with a wide angle of view.

### BRIEF DESCRIPTION OF THE DRAWINGS

FIG. 1 is a diagram illustrating a lens configuration of an imaging lens according to Embodiment 1 of the present disclosure.

FIG. 2A is an aberration diagram of the imaging lens according to Embodiment 1 of the present disclosure.

FIG. 2B is an MTF of the imaging lens according to Embodiment 1 of the present disclosure.

FIG. 2C is a distortion grid of the imaging lens according to Embodiment 1 of the present disclosure.

FIG. 3 is a diagram illustrating a lens configuration of an imaging lens according to Embodiment 2 of the present disclosure.

FIG. 4A is an aberration diagram of the imaging lens according to Embodiment 2 of the present disclosure.

FIG. 4B is an MTF of the imaging lens according to Embodiment 2 of the present disclosure.

FIG. 4C is a distortion grid of the imaging lens according to Embodiment 2 of the present disclosure.

FIG. 5 is a diagram illustrating a lens configuration of an imaging lens according to Embodiment 3 of the present disclosure.

FIG. 6A is an aberration diagram of the imaging lens according to Embodiment 3 of the present disclosure.

FIG. 6B is an MTF of the imaging lens according to Embodiment 3 of the present disclosure.

FIG. 6C is a distortion grid of the imaging lens according to Embodiment 3 of the present disclosure.

FIG. 7 is a diagram illustrating a lens configuration of an imaging lens according to Embodiment 4 of the present disclosure.

FIG. 8A is an aberration diagram of the imaging lens according to Embodiment 4 of the present disclosure.

FIG. 8B is an MTF of the imaging lens according to Embodiment 4 of the present disclosure.

FIG. 8C is a distortion grid of the imaging lens according to Embodiment 4 of the present disclosure.

FIG. 9 is a diagram illustrating a lens configuration of an imaging lens according to Embodiment 5 of the present disclosure.

FIG. 10A is an aberration diagram of the imaging lens according to Embodiment 5 of the present disclosure.

FIG. 10B is an MTF of the imaging lens according to Embodiment 5 of the present disclosure.

FIG. 10C is a distortion grid of the imaging lens according to Embodiment 5 of the present disclosure.

FIG. 11 is a diagram illustrating a lens configuration of an imaging lens according to Embodiment 6 of the present disclosure.

FIG. 12A is an aberration diagram of the imaging lens according to Embodiment 6 of the present disclosure.

FIG. 12B is an MTF of the imaging lens according to Embodiment 6 of the present disclosure.

FIG. 12C is a distortion grid of the imaging lens according to Embodiment 6 of the present disclosure.

FIG. 13 is a diagram illustrating a lens configuration of an imaging lens according to Embodiment 7 of the present disclosure.

FIG. 14A is an aberration diagram of the imaging lens according to Embodiment 7 of the present disclosure.

FIG. 14B is an MTF of the imaging lens according to Embodiment 7 of the present disclosure.

FIG. 14C is a distortion grid of the imaging lens according to Embodiment 7 of the present disclosure.

FIG. 15 is a diagram illustrating a lens configuration of an imaging lens according to Embodiment 8 of the present disclosure.

FIG. 16A is an aberration diagram of the imaging lens according to Embodiment 8 of the present disclosure.

FIG. 16B is an MTF of the imaging lens according to Embodiment 8 of the present disclosure.

FIG. 16C is a distortion grid of the imaging lens according to Embodiment 8 of the present disclosure.

FIG. 17 is a diagram illustrating a lens configuration of an imaging lens according to Embodiment 9 of the present disclosure.

FIG. 18A is an aberration diagram of the imaging lens according to Embodiment 9 of the present disclosure.

FIG. 18B is an MTF of the imaging lens according to Embodiment 9 of the present disclosure.

FIG. 18C is a distortion grid of the imaging lens according to Embodiment 9 of the present disclosure.

FIG. 19 is a diagram illustrating a lens configuration of an imaging lens according to Embodiment 10 of the present disclosure.

FIG. 20A is an aberration diagram of the imaging lens according to Embodiment 10 of the present disclosure.

FIG. 20B is an MTF of the imaging lens according to Embodiment 10 of the present disclosure.

FIG. 20C is a distortion grid of the imaging lens according to Embodiment 10 of the present disclosure.

FIG. 21 is a diagram illustrating a schematic configuration of an information processing apparatus including an imaging device having an imaging lens according to each embodiment of the present disclosure.

FIG. 22 is a diagram illustrating the schematic configuration of the imaging device of FIG. 21.

FIG. 23 is a block diagram illustrating a functional configuration of the information processing apparatus including the imaging device having the imaging lens according to each embodiment of the present disclosure.

### DETAILED DESCRIPTION

Hereinafter, an imaging lens, an imaging device, and an information processing apparatus according to one or more embodiments of the present disclosure will be described with reference to the accompanying drawings. The present disclosure is not limited to the following embodiments. In addition, in the following description, each drawing referred to is merely illustrated in an outline of shape, size, and positional relationship to the extent that the contents of the present disclosure can be understood. That is, the present disclosure is not limited to the shapes, sizes, and positional relationships illustrated in each drawing. In addition, the same reference numeral is attached to the same parts, and detailed descriptions will be omitted.

### EMBODIMENTS

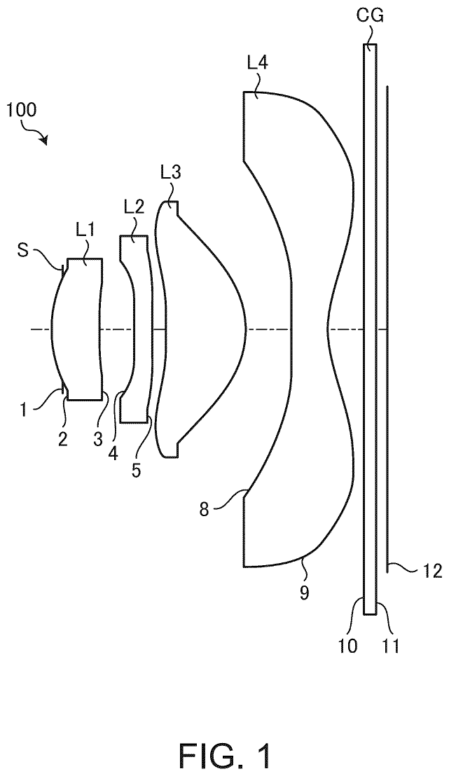

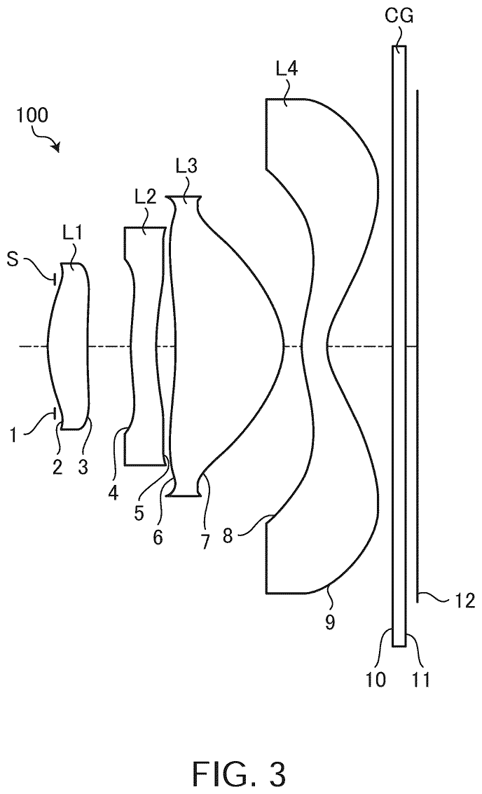

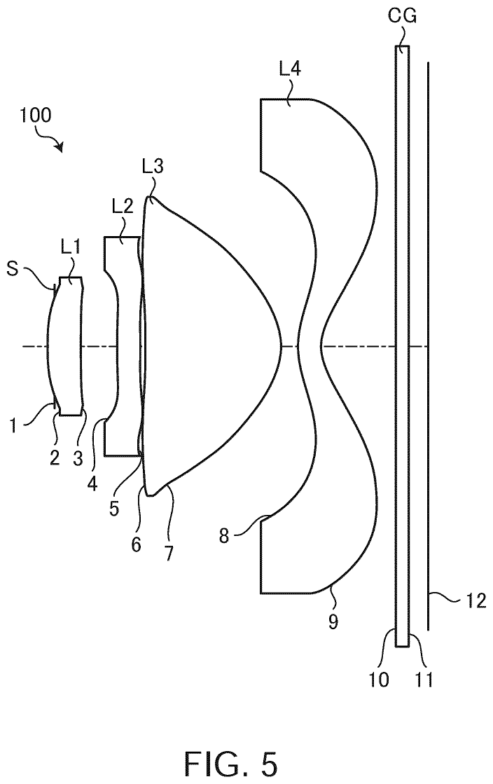

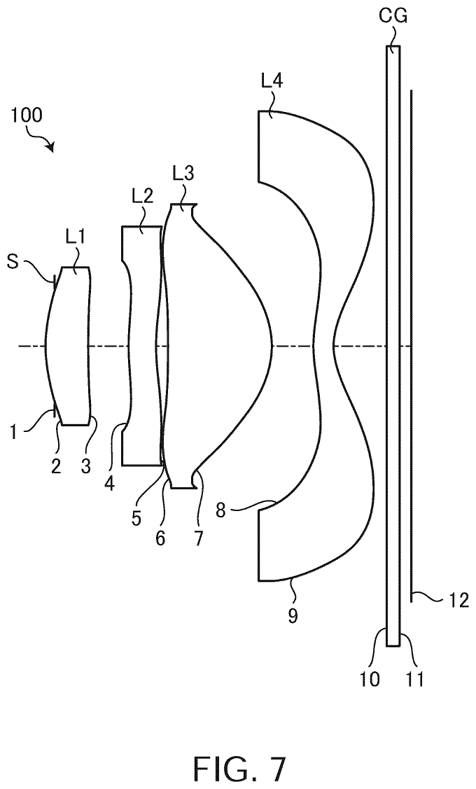

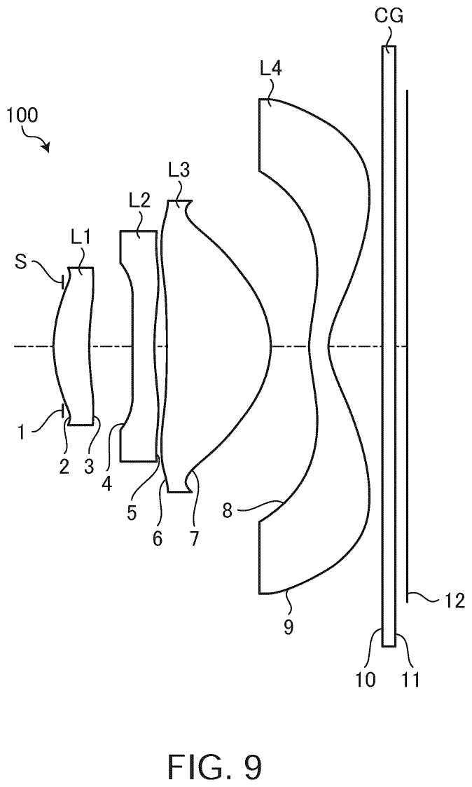

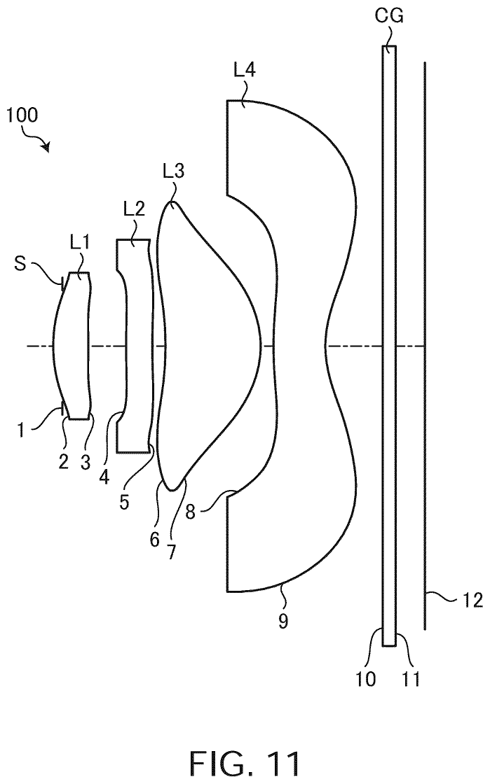

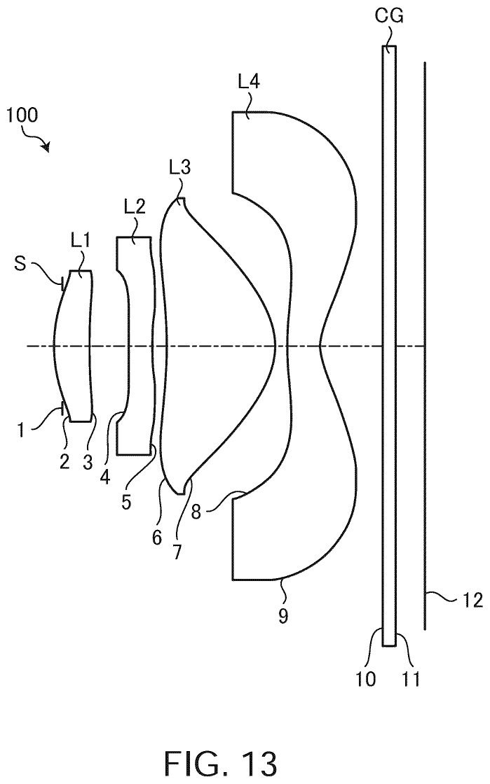

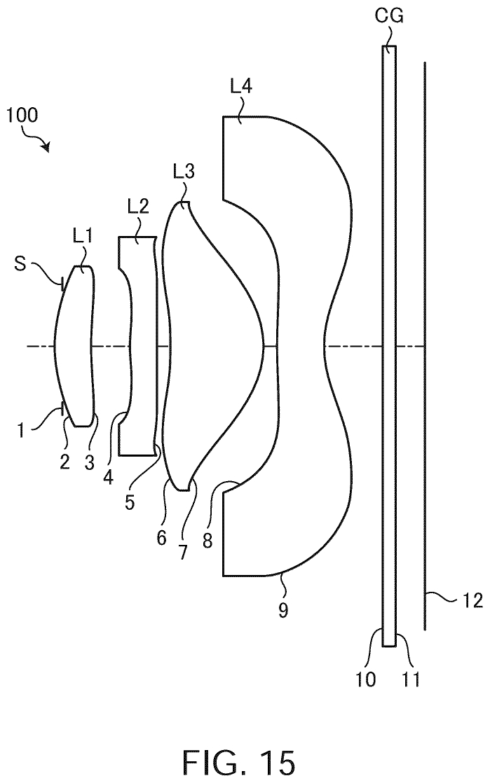

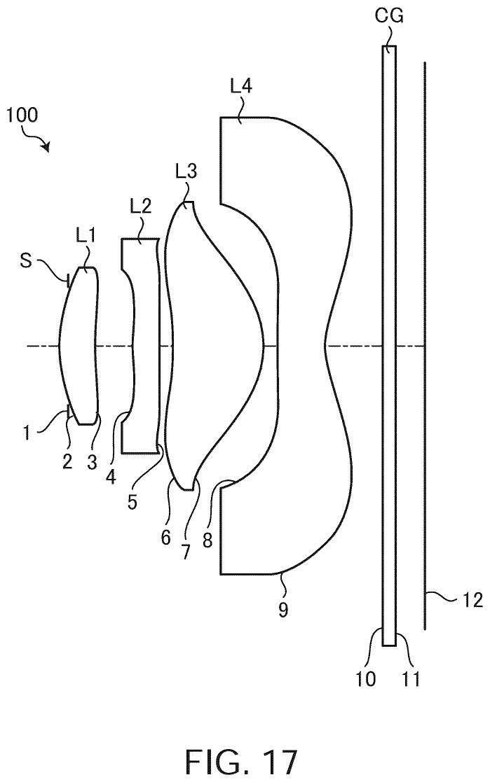

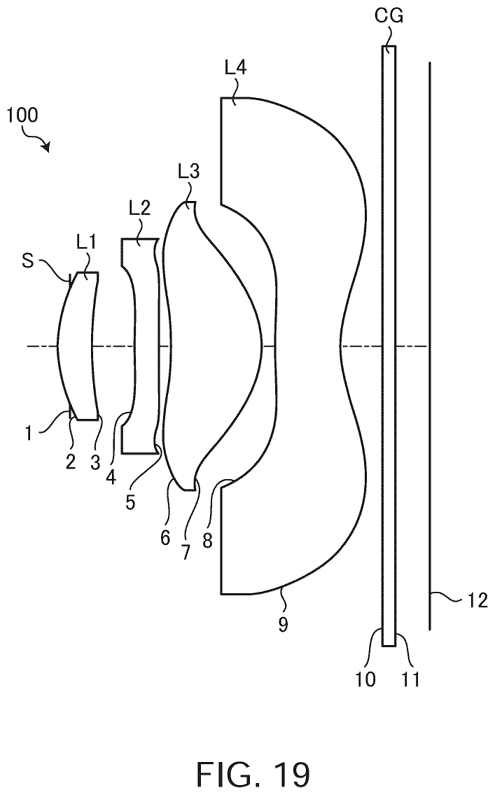

FIGS. 1, 3, 5, 7, 9, 11, 13, 15, 17, and 19 are cross-sectional views illustrating the lens configurations of the imaging lenses of Embodiments 1 to 10, respectively. In each cross-sectional view, a left is an object side (front), and a right is an image side (rear).

An imaging lens 100 according to one or more embodiments includes a first lens L1, a second lens L2, a third lens L3, and a fourth lens L4 that are disposed in order from the object side to the image side. Furthermore, the imaging lens 100 includes an aperture stop S (STOP) disposed on the object side of the first lens L1.

In FIGS. 1, 3, 5, 7, 9, 11, 13, 15, 17, and 19, reference numerals 1 to 9 attached to any of the first lens L1 to the fourth lens L4 or the aperture stop S represent the surfaces of each lens or the stop. Hereinafter, these surfaces are referred to as surface 1 to surface 9 in order from the object side to the image side. The surface 1 is the surface of the aperture stop S. Furthermore, in FIGS. 1, 3, 5, 7, 9, 11, 13, 15, 17, and 19, a reference numeral CG represents a transparent parallel flat plate equivalent to a plate having at least one or more of a cover glass of a solid-state imaging element and various filters. An incident side surface of the transparent parallel flat plate CG is referred to as a surface 10, and an image side surface is referred to as a surface 11.

In the imaging lens 100, the aperture stop S and the first to fourth lenses L1 to L4 are disposed in order from a foremost object side. In the imaging lens 100, the first lens L1 is a positive lens, and the second lens is a lens with positive or negative power. In addition, in the imaging lens 100, the third lens is a positive lens and the fourth lens is a negative lens. Furthermore, in the imaging lens 100, the foremost object side is a positive lens, and the lens on an image plane side is a negative lens. In such a lens configuration, the incidence angle of light rays tends to be low, and the fourth lens L4 of the final lens is the negative lens, so that the emission angle of light rays is large, but good telecentricity on the image side can be realized by appropriately correcting the power balance of the lens.

The first lens L1 is a positive meniscus lens having a convex surface facing the object side, and the image plane side may have an inflection point in the lens peripheral portion. Here, the inflection point of the peripheral portion is a region including 60% to 80% of the position from the optical axis toward the outer edge with respect to the diameter of the first lens L1 on the surface 2 side.

The second lens L2 is configured using a positive or negative lens having an inflection point on at least one surface with a low thickness deviation ratio, but the inflection points may be located on both surfaces.

The third lens L3 is configured using a positive lens having a convex surface facing the image plane side and an inflection point on the lens peripheral portion of the object side surface.

The fourth lens L4 is configured using a negative lens having a concave surface on the image plane side and an inflection point on the peripheral portion.

The first lens L1 to the fourth lens L4 configured as described above are all aspherical lenses, and each of which has a characteristic aspherical shape. Furthermore, by designing the first lens L1 and the fourth lens L4 to have shapes with inflection points, it is possible to achieve high degree of aberration corrections while reducing the thickness (total length) of the imaging lens 100 in the optical direction.

In addition, regarding the material of the lens, as illustrated in the examples described later, an optical plastic material or a glass material can be used.

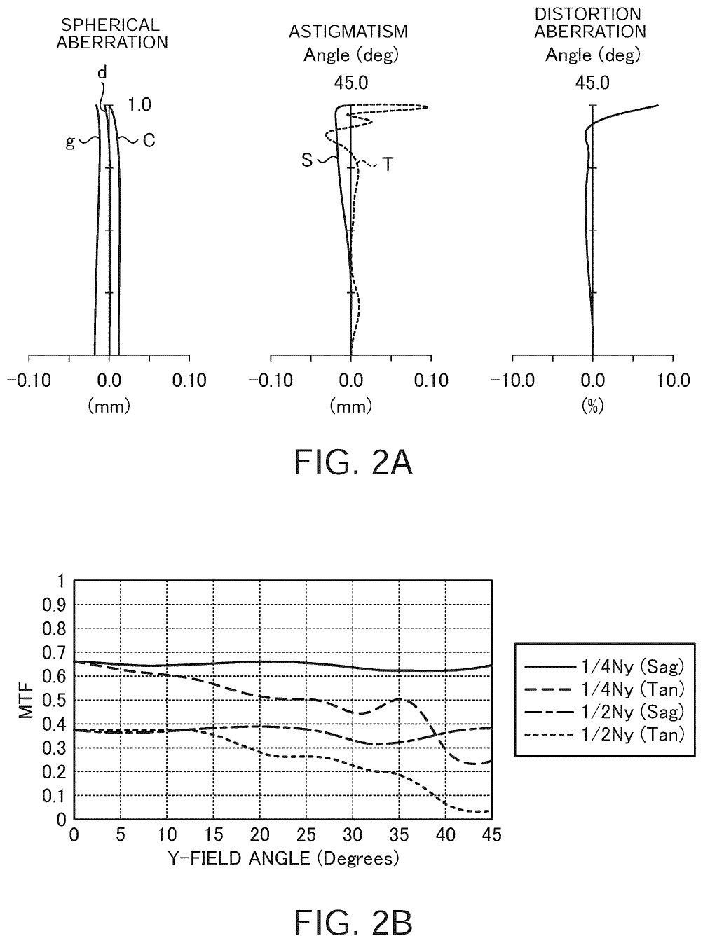

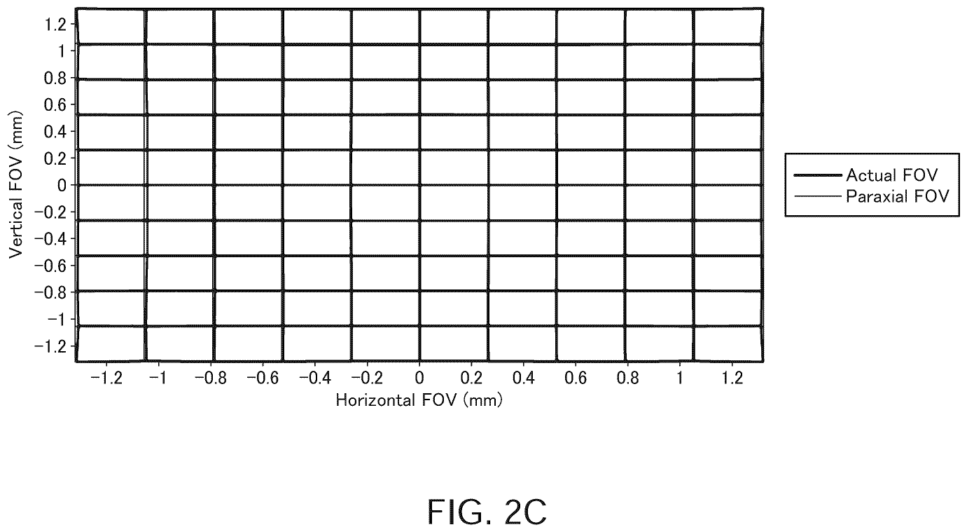

FIGS. 2A to 2C, FIGS. 4A to 4C, FIGS. 6A to 6C, FIGS. 8A to 8C, FIGS. 10A to 10C, FIGS. 12A to 12C, FIGS. 14A to 14C, FIGS. 16A to 16C, FIGS. 18A to 18C, and FIGS. 20A to 20C are vertical aberration diagrams, MTF, and distortion grids of the imaging lens 100 of Embodiments 1 to 10, respectively. The spherical aberration diagram illustrates the amount of spherical aberration with respect to each of the d-line (yellow: wavelength 587.6 nm), the g-line (blue: wavelength 435.8 nm), and the C-line (red: wavelength 653.3 nm). In addition, in the astigmatism diagram, the solid line S illustrates the amount of astigmatism on the sagittal image plane, and the broken line T illustrates the amount of astigmatism on the tangential image plane. Furthermore, the distortion aberration diagram illustrates the amount of distortion aberration only for the d-line. In addition, Angle (deg) illustrates the imaging half angle of view (°). In addition, in the MTF, the frequency is ¼Ny and ½Ny. A five-point chain line illustrates the MTF of the sagittal image plane, and a rough broken line illustrates the MTF of the tangential image plane at ¼Ny. A three-point chain line illustrates the MTF of the sagittal image plane, and a fine broken line illustrates the MTF of the tangential image plane at ½Ny. In addition, regarding the distortion grid, a thin line illustrates a paraxial FOV (ideal) grid and a thick line illustrates an actual FOV grid.

Next, the conditions of the imaging lens 100 according to one or more embodiments will be described.

The imaging lens 100 according to one or more embodiments satisfies following Conditions (1) and (2) when the focal length of the first lens L1 is denoted by f1, the focal length of the fourth lens L4 is denoted by f4, and the focal length of the entire optical system is denoted by f.

$$0.45 < \vert f / f 1 \vert < 0.8 \qquad ( 1 )$$

$$0.25 < \vert f 4 / f 1 \vert < 0.5 \qquad ( 2 )$$

Condition (1) is a conditional expression related to the entire focal length of the imaging lens 100 and the lens power of the first lens L1.

In a case where f/f1 is equal to or less than the lower limit of Condition (1), the entire focal length tends to be short, which is advantageous for achieving a wide angle. However, the astigmatism tends to be excessive, and the distortion aberration also tends to increase, making it difficult to realize the desired performance. In addition, in a case where f/f1 is equal to or greater than the upper limit of Condition (1), although the spherical aberration and the astigmatism tend to be improved, the angle of view tends to be narrowed, making it undesirable as the desired performance in one or more embodiments of the present disclosure cannot be achieved. Therefore, the imaging lens 100 can realize a balance between shortening (reduction in height) and high performance by satisfying Condition (1).

Condition (2) is a conditional expression related to the positive power of the first lens L1 and the negative power of the fourth lens L4.

In a case where |f4/f1| is equal to or less than the lower limit of Condition (2), the astigmatism tends to be excessive, and the spherical aberration is also generated to a large extent, making it difficult to realize the desired performance. In addition, in a case where |f4/f1| is equal to or greater than the upper limit of Condition (2), the spherical aberration tends to be under-corrected, so that the balance with the astigmatism is lost, and it is difficult to realize the desired performance.

That is, when the imaging lens 100 satisfies Condition (1) and Condition (2), a balance between the spherical aberration and the astigmatism is achieved and the bright, high-performance, and small (compact) imaging lens 100 can be realized. Here, the small size means reducing the thickness by shortening the total length of the imaging lens 100 in the optical axis direction and reducing the diameter of the imaging lens 100.

In addition, in the imaging lens 100 according to one or more embodiments, Condition (3) is satisfied, when the refractive index of the material of the first lens L1 with respect to the d-line is denoted by N1 and the refractive index of the material of the fourth lens L4 with respect to the d-line is denoted by N4.

$$N 1 < N 4 \qquad ( 3 )$$

Condition (3) defines the relationship between the refractive index N1 of the material of the first lens L1 and the refractive index N4 of the material of the fourth lens L4.

The first lens L1 is a positive lens. In addition, the fourth lens L4 is a negative lens. In the disclosure, in order to appropriately correct chromatic aberration and balance miniaturization, the refractive index N1 of the first lens L1 is formed with a material with a refractive index smaller than the refractive index N4 of the fourth lens L4, and the desired good chromatic aberration can be realized by satisfying Condition (3).

In addition, in the imaging lens 100 of one or more embodiments, Condition (4) is satisfied, when the refractive index of the material of the first lens L1 with respect to the d-line is denoted by N1.

$$1.49 < N 1 < 1.55 \qquad ( 4 )$$

In a case where the refractive index N1 is equal to or less than the lower limit of Condition (4), the optical performance is further improved, but the cost is increased, which is not preferable. In addition, in a case where the refractive index N1 is equal to or greater than the upper limit of Condition (4), the optical performance is not preferable because chromatic aberration is affected. Therefore, when the imaging lens 100 satisfies Condition (4), a balance between cost and chromatic aberration is achieved, and the bright, high-performance, and small (compact) imaging lens 100 can be realized.

In addition, in the imaging lens 100 of one or more embodiments, Condition (5) is satisfied, when the refractive index of the material of the fourth lens L4 with respect to the d-line is denoted by N4.

$$1.63 < N 4 < 1.67 \qquad ( 5 )$$

In a case where the refractive index N4 is equal to or less than the lower limit of Condition (5) or in a case where the refractive index N4 is equal to or greater than the upper limit of Condition (5), the balance with the chromatic aberration is lost. In consideration of the balance between cost and chromatic aberration, when Condition (5) is satisfied, the bright, high-performance, and small imaging lens 100 can be realized.

In addition, the imaging lens 100 according to one or more embodiments satisfies Condition (6) when the focal length of the entire optical system (imaging lens 100) is denoted by f and the total length of the optical system (imaging lens 100 in the longitudinal direction) is denoted by OAL.

$$0.6 < f / OAL < 0.75 \qquad ( 6 )$$

Condition (6) is a condition that balances the focal length f of the entire optical system and the total length OAL.

In the imaging lens 100 according to one or more embodiments, in a case where f/OAL is equal to or less than the lower limit of Condition (6), a further wide angle can be realized, but the diameter of the front lens tends to increase, which may lead to an increase in size. In addition, in a case where f/OAL is equal to or greater than the upper limit of Condition (6), the total length of the optical system is reduced, but it is difficult to achieve a wide angle of view. The imaging lens 100 satisfying Condition (6) can realize miniaturization in size and a wide angle.

In addition, in the imaging lens 100 according to one or more embodiments, Condition (7) is satisfied, when the total length of the optical system is denoted by OAL and the optical effective diameter of the lens (first lens L1) disposed on the foremost object side is denoted by EfD1.

$$2.9 < OAL / EfD 1 < 3.6 \qquad ( 7 )$$

Condition (7) is a condition that balances the total length of the lens and the diameter of the front lens of the lens (first lens L1).

In a case where OAL/EfD1 is equal to or less than the lower limit of Condition (7), the optical system is miniaturized (shortened in the optical axis direction), but it is difficult to achieve a wide angle of view. In a case where OAL/EfD1 is equal to or greater than the upper limit of Condition (7), the performance of the optical system is improved, but it is difficult to achieve miniaturization (shortening in the optical axis direction). The imaging lens 100 can realize miniaturization (shortening in the optical axis direction) and high performance by satisfying Condition (7).

In addition, in the imaging lens 100 according to one or more embodiments, Condition (8) is satisfied, when the position of the exit pupil is denoted by EXP and the image height is denoted by IH.

$$- 0.94 < EXP / IH < - 0.7 \qquad ( 8 )$$

Condition (8) is a condition for optimizing the incidence angle of light rays on the image plane.

In a case where EXP/IH is equal to or less than the lower limit of Condition (8), the incidence angle of light rays tends to decrease, but it becomes difficult to reduce the total length of the optical system and miniaturize the optical system. In addition, in a case where EXP/IH is equal to or greater than the upper limit of Condition (8), the incidence angle of light rays tends to increase. Therefore, the imaging lens 100 can realize miniaturization by satisfying Condition (8).

In addition, in the imaging lens 100 according to one or more embodiments, Condition (9) is satisfied, when the focal length of the first lens L1 is denoted by f1 and the focal length of the second lens L2 is denoted by f2.

$$0.01 < \vert f 1 / f 2 \vert < 0.4 \qquad ( 9 )$$

Condition (9) is a condition related to the balance of the focal lengths of the first lens L1 and the second lens L2.

In a case where |f1/f2| is equal to or less than the lower limit of Condition (9), the lens power of f2 with respect to f1 is weakened, and thus the spherical aberration and the distortion aberration are likely to be insufficient for aberration correction, making it difficult to achieve high performance. In addition, in a case where |f1/f2| is equal to or greater than the upper limit of Condition (9), the astigmatism tends to increase, which is undesirable. Therefore, the imaging lens 100 can realize high performance by satisfying Condition (9).

In addition, in the imaging lens 100 according to one or more embodiments, Condition (10) is satisfied, when the focal length of the first lens L1 is denoted by f1 and the focal length of the third lens L3 is denoted by f3.

$$0.25 < f 3 / f 1 < 0.55 \qquad ( 10 )$$

Condition (10) is a conditional expression related to the positive power of the first lens L1 and the positive power of the third lens L3.

In a case where f3/f1 is equal to or less than the lower limit of Condition (10), the astigmatism tends to be excessive, and the distortion aberration and the coma aberration also occur significantly, making it difficult to realize the desired performance. In addition, in a case where f3/f1 is equal to or greater than the upper limit of Condition (10), the spherical aberration tends to be under-corrected, so that the balance with the astigmatism is lost, and it is difficult to realize the desired performance.

In addition, in the imaging lens 100 according to one or more embodiments, Condition (11) is satisfied, when the focal length of the third lens L3 is denoted by f3 and the focal length of the fourth lens L4 is denoted by f4.

$$0.7 < \vert f 3 / f 4 \vert < 1.3 \qquad ( 11 )$$

Condition (11) is a conditional expression related to the lens power of the third lens L3 and the lens power of the fourth lens L4.

In a case where f3/f4 is equal to or less than the lower limit of Condition (11), the astigmatism tends to be excessive, and the distortion aberration also tends to increase, making it difficult to realize the desired performance. In addition, in a case where f3/f4 is equal to or greater than the upper limit of Condition (11), the entire focal length is increased and the angle of view tends to be narrowed, so that the astigmatism and the distortion aberration tend to be improved, but the spherical aberration tends to increase, making it difficult to realize the desired performance. Therefore, the imaging lens 100 can realize a balance between shortening (reduction in height) and high performance by satisfying Condition (11).

In addition, in the imaging lenses 100 of Embodiments 1 to 5, Condition (16) is satisfied, when the second lens L2 has a negative power, the focal length of the second lens L2 is denoted by f2, and the focal length of the entire optical system is denoted by f.

$$- 0.2 < f / f 2 < - 0. \qquad ( 16 )$$

Condition (16) is a conditional expression related to the focal length of the second lens L2 and the focal length of the entire optical system.

In a case where f/f2 is equal to or less than the lower limit of Condition (16), the power of the f2 lens with respect to f strengthened, and the astigmatism and the distortion aberration tend to be insufficient for aberration correction, making it difficult to achieve high performance. Therefore, the imaging lens 100 can realize high performance by satisfying Condition (16).

In addition, in the imaging lenses 100 according to Embodiments 6 to 10, Condition (16) is satisfied, when the second lens L2 has a positive power, the focal length of the second lens L2 is denoted by f2, and the focal length of the entire optical system is denoted by f.

$$0. < f / f 2 < 0.25 \qquad ( 17 )$$

Condition (17) is a conditional expression related to the focal length of the second lens L2 and the focal length of the entire optical system.

In a case where f/f2 is equal to or greater than the upper limit of Condition (17), the lens of f2 with respect to f is strengthened, and the astigmatism and the distortion aberration tend to be insufficient for aberration correction, making it difficult to achieve high performance. Therefore, the imaging lens 100 can realize high performance by satisfying Condition (17).

### [Imaging Device]

Next, an embodiment of an information processing apparatus (PC) including an imaging device that uses the imaging lens 100 according to one or more embodiments as an imaging optical system will be described.

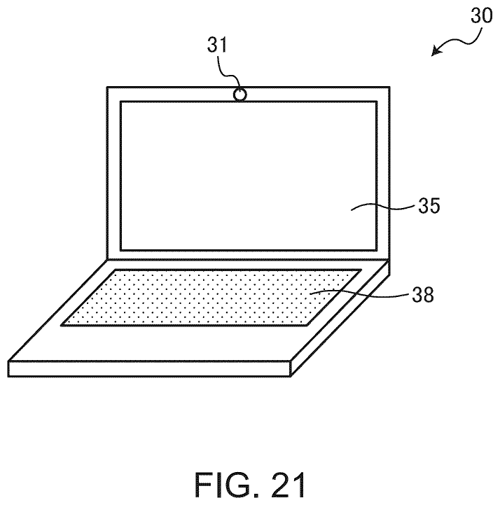

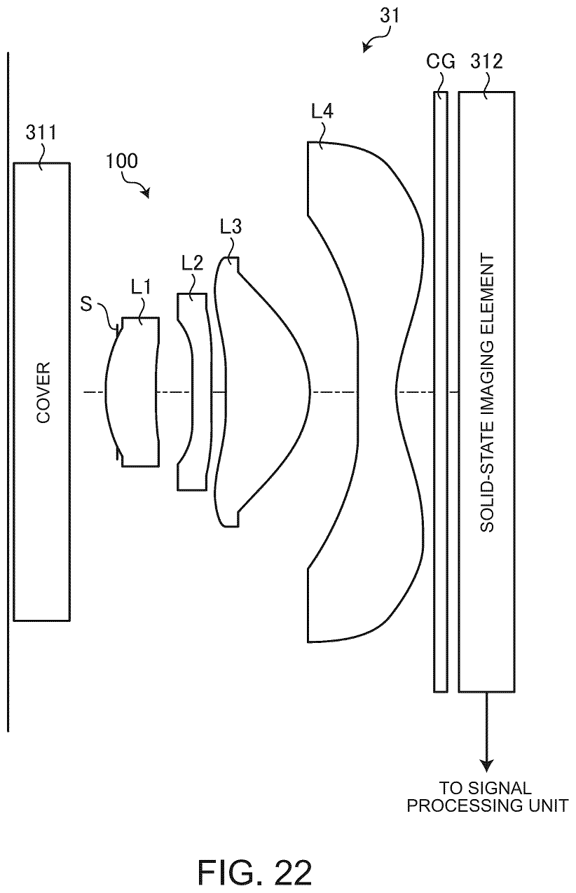

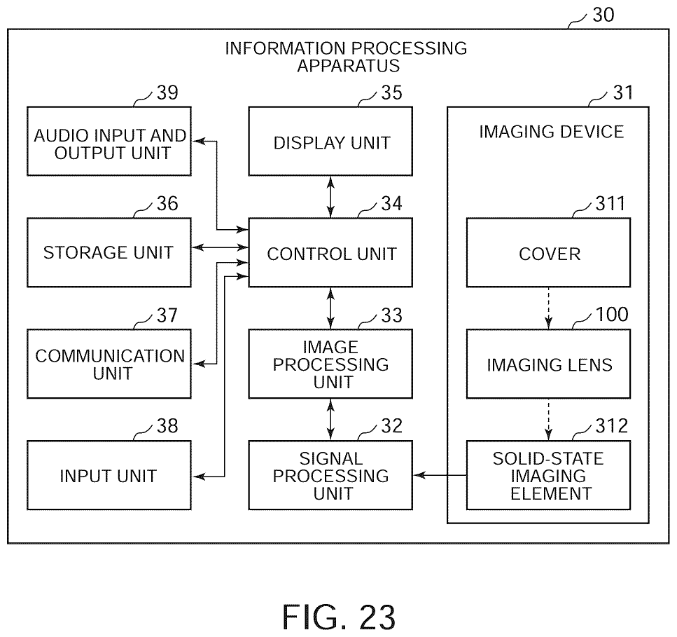

FIG. 21 is a diagram illustrating a schematic configuration of an information processing apparatus including an imaging device having the imaging lens 100 according to one or more embodiments. FIG. 22 is a diagram illustrating a schematic configuration of the imaging device of FIG. 21. FIG. 23 is a block diagram illustrating the functional configuration of the information processing apparatus including the imaging device having the imaging lens according to one or more embodiments.

An information processing apparatus 30 illustrated in FIGS. 21 to 23 includes at least an imaging device 31, a signal processing unit 32, an image processing unit 33, a control unit 34, a display unit 35, a storage unit 36, a communication unit 37, an input unit 38, and an audio input and output unit 39.

The imaging device 31 generates an imaging signal by capturing a predetermined visual field region under the control of the control unit 34 and outputs the imaging signal to the signal processing unit 32. As illustrated in FIG. 22, the imaging device 31 includes at least a cover 311, the imaging lens 100 according to one or more embodiments, and a solid-state imaging element 312. The imaging device 31 is disposed on the front surface side of the information processing apparatus 30. Specifically, the imaging device 31 is disposed at a position where the user of the information processing apparatus 30 can be imaged. As a matter of course, the disposition position of the imaging device 31 can be appropriately changed according to the shape, size, and usage aspect of the information processing apparatus 30.

The cover 311 is configured using a cover glass or the like, which serves as a member for protecting the imaging lens 100 from dirt and dust. The information processing apparatus 30 may further include a lid or the like that can be opened and closed with respect to the cover 311 in accordance with the operation of the user.

The solid-state imaging element 312 receives an image of an imaging target object formed by the imaging lens 100 and performs photoelectric conversion to generate an imaging signal. The solid-state imaging element 312 is configured using a CCD sensor, a CMOS sensor, or the like. The solid-state imaging element 312 preferably has 8 million pixels or more, so-called 4K or more (3840×2160 or more) effective pixels disposed in a two-dimensional matrix.

The signal processing unit 32, under the control of the control unit 34, performs A/D conversion processing or the like on the imaging signal input from the solid-state imaging element 312 to convert the imaging signal into a digital imaging signal, and outputs the digital imaging signal to the image processing unit 33. The signal processing unit 32 is configured using, for example, a digital signal processor (DSP) or the like.

The image processing unit 33, under the control of the control unit 34, performs predetermined image processing on the digital imaging signal input from the signal processing unit 32 and outputs the processed signal to the display unit 35 or the storage unit 36. The image processing unit 33 is configured using, for example, a graphics processing unit (GPU) or the like. Here, the predetermined image processing includes electrical correction processing of shading, white balance adjustment processing, trimming processing of an image center part, noise reduction processing, and the like.

The control unit 34 controls each component that constitutes the information processing apparatus 30. The control unit 34 includes a processor and a memory. The processor is configured using a CPU, a field-programmable gate array (FPGA), or the like. The memory is configured using a random access memory (RAN), a read-only memory (ROM), or the like.

The display unit 35, under the control of the control unit 34, displays a video during imaging on which the image processing unit 33 performs image processing, a captured image, a still image corresponding to the image signal stored in the storage unit 36, and various types of information on the information processing apparatus 30.

The storage unit 36 stores various types of information on the information processing apparatus 30, programs executed by the information processing apparatus 30, and imaging signals (PAW data or JPEG data) captured by the imaging device 31. The storage unit 36 is configured using a flash memory, a solid state drive (SSD), a hard disk drive (HDD), a memory card, and the like.

The communication unit 37, under the control of the control unit 34, transmits the imaging signal captured by the imaging device 31 to the outside via the network in accordance with a predetermined communication standard and receives various types of information input from the outside. For example, the communication unit 37 uses the communication standard conforming to 4G, LTE, 5G, WiMAX, Wi-Fi (registered trademark), or the like, established by 3GPP (registered trademark) and IEEE.

The input unit 38 receives an operation input by the user and outputs operation information corresponding to the received operation to the control unit 34. The input unit 38 is configured using, for example, a touch panel, a keyboard, a mouse, or the like.

The audio input and output unit 39, under the control of the control unit 34, receives the input of ambient sound, converts the ambient sound into an audio signal, and outputs the audio signal to the storage unit 36 or the communication unit 37. In addition, the audio input and output unit 39, under the control of the control unit 34, converts the audio signal input from the storage unit 36 or the communication unit 37 and outputs the converted audio signal to the outside. The audio input and output unit 39 is configured using a microphone, a speaker, or the like.

In the information processing apparatus 30 configured as described above, it is possible to perform communication with an external device through Web communication via a network at a high image quality of 4K by using the imaging device 31 including the imaging lens 100.

In one or more embodiments, although the PC has been described as an example of the information processing apparatus 30, the imaging device 31 can be applied to, for example, the imaging device such as a tablet-type terminal and a mobile phone. As a matter of course, the imaging device 31 may be applied to a Web camera or the like that can communicate with a PC or the like through wired or wireless communication.

According to one or more embodiments described above, it is possible to realize a bright, high-performance, and small device with a wide angle of view.

In addition, according to one or more embodiments, the half angle of view of approximately 50° can be realized with four lenses.

In addition, according to one or more embodiments, since the imaging lens 100 can realize a device having a wide angle of view, a small F-number, high performance, and small size, it is possible to cope with imaging in various environments, such as dark environments, and high-speed imaging in the case of video recording.

In addition, according to one or more embodiments, since it is possible to realize a bright, high-performance, and small device with a wide angle of view, it is possible to improve the matching between the angle of incidence on a light receiving element of the solid-state imaging element and the light rays incident on the light receiving surface on the image side.

In addition, according to one or more embodiments, since the bright, high-performance, and small half angle of view of approximately 50° can be configured with four lenses, the four lenses can be used as a single focal length lens used in mobile phones such as smartphones or PCs. Therefore, in a case where video recording with a high pixel of 4K or more (3840×2160 or more) is required, sufficient aberration correction can be performed compared to the imaging lens in the related art, and the required performance can be met.

In addition, according to one or more embodiments, since the bright, high-performance, and small half angle of view of approximately 50° can be configured with four pieces, the total length of the imaging lens 100 in the optical axis direction can be shortened, the lens diameter can be reduced, and miniaturization can be realized. Therefore, the refractive power of the miniaturized lens is reduced, and the effect of manufacturing error and assembly error can be reduced. As a result, productivity is improved, and production costs can be reduced.

A plurality of components disclosed in the information processing apparatus according to one or more embodiments of the present disclosure can be combined as appropriate to form various inventions. For example, some components may be deleted from all the components described in the information processing apparatus according to one or more embodiments of the present disclosure. Furthermore, the components described in the information processing apparatus according to one or more embodiments of the present disclosure may be combined as appropriate.

In addition, in the information processing apparatus according to one or more embodiments of the present disclosure, the “unit” described above can be interpreted as “means,” “circuit,” and the like. For example, the control unit can be interpreted as control means or a control circuit.

In addition, the program executed by the information processing apparatus according to one or more embodiments of the present disclosure is recorded and provided on a recording medium such as a CD-ROM, a flexible disk (FD), a CD-R, a digital versatile disk (DVD), a USB medium, or a flash memory or the like, which can be read by a computer, with file data of an installable format or an executable format.

In addition, the program executed by the information processing apparatus according to one or more embodiments of the present disclosure may be stored on a computer connected to a network such as the Internet or the like and provided by being downloaded via the network.

### EXAMPLES

Hereinafter, Examples 1 to 10 of the imaging lens 100 corresponding to each of Embodiments 1 to 10 will be illustrated.

The meanings of the symbols in each example are as follows.
f: focal length of the entire lens system
f1: focal length of each lens
FNo.: the number of apertures (F number)
R: radius of curvature of the surface
D: interfacial distance
Nd: refractive index for d-line
Vd: Abbe number for d-line
SD: effective radius

The aspherical surface is represented by a well-known expression (15) using an aspherical coefficient in a case where a depth in an optical axis direction is represented by X, a height from the optical axis is denoted by H, a paraxial curvature radius is denoted by R, a conical constant is denoted by k, and a high-order aspherical coefficient is denoted by CN (N is an even number of 4 or more).

$$X = ( {H}^{2} / R ) / [ 1 + {\{ 1 - {k ( H / r )}^{2} \}}^{1 / 2} ] + {\sum }_{N = 4 : even} {CNH}^{N} \qquad ( 15 )$$

Here, Σ_{N≥4: even} represents a sum for even numbers of N of 4 or more.

### Example 1

f=2.1 mm, FNo.=2.2, HFOV=45°

Table 1 illustrates the data from Example 1.

TABLE 1

| No | R | D | Nd | Vd | SD | fl |
|---|---|---|---|---|---|---|
| 1 | — | −0.1 | | | 0.48 | |
| 2 | 1.156 | 0.431 | 1.5365 | 55.98 | 0.48 | 2.8 |
| 3 | 3.840 | 0.301 | | | 0.56 | |
| 4 | 54.254 | 0.165 | 1.6606 | 20.40 | 0.61 | −12.3 |
| 5 | 7.802 | 0.122 | | | 0.75 | |
| 6 | −2.906 | 0.715 | 1.5365 | 55.98 | 0.88 | 1.4 |
| 7 | −0.693 | 0.401 | | | 1.02 | |
| 8 | −46.629 | 0.329 | 1.6328 | 23.29 | 1.47 | −1.3 |
| 9 | 0.885 | 0.326 | | | 1.97 | |
| 10 | — | 0.11 | 1.52 | 64.20 | 2.22 | — |
| 11 | — | 0.1 | | | 2.26 | |
| 12 | — | — | | | | |

The aspherical data is illustrated below.

TABLE 2

| | 2 | 3 | 4 | 5 |
|---|---|---|---|---|
| Conic | −6.9545.E−01 | 3.6715.E+01 | −2.5000.E+02 | −2.3297.E+02 |
| constant (k) | | | | |
| 4th order | 2.4850.E−02 | −1.4880.E−01 | −6.2888.E−01 | −2.9809.E−01 |
| coefficients | | | | |
| 6th order | 1.3138.E+00 | −6.0323.E−01 | −5.3950.E−01 | −1.1573.E−01 |
| coefficients | | | | |
| 8th order | −2.1558.E+01 | 4.6385.E+00 | 4.7279.E−01 | 9.9894.E−02 |
| coefficients | | | | |
| 10th order | 1.9018.E+02 | −4.0881.E+01 | −3.4155.E+00 | 3.8426.E−01 |
| coefficients | | | | |
| 12th order | −9.2250.E+02 | 1.5398.E+02 | 1.1366.E−01 | 5.4935.E−01 |
| coefficients | | | | |
| 14th order | 2.2957.E+03 | −3.0917.E+02 | 6.6008.E−01 | 9.9747.E−02 |
| coefficients | | | | |
| 16th order | −2.2969.E+03 | 2.1981.E+02 | 0.0000.E+00 | 0.0000.E+00 |
| coefficients | | | | |
| 18th order | 0.0000.E+00 | 0.0000.E+00 | 0.0000.E+00 | 0.0000.E+00 |
| coefficients | | | | |
| 20th order | 0.0000.E+00 | 0.0000.E+00 | 0.0000.E+00 | 0.0000.E+00 |
| coefficients | | | | |
| | 6 | 7 | 8 | 9 |
| Conic | 6.7752.E+00 | −2.3833.E+00 | 9.2256.E+02 | −6.6377.E+00 |
| constant (k) | | | | |
| 4th order | 5.1904.E−02 | −1.0005.E−01 | −1.4349.E−01 | −6.7085.E−02 |
| coefficients | | | | |
| 6th order | −8.2763.E−03 | −7.0803.E−01 | −1.4803.E−01 | −1.5742.E−01 |
| coefficients | | | | |
| 8th order | −4.1636.E−01 | 2.3787.E+00 | 1.2297.E−01 | 3.5675.E−01 |
| coefficients | | | | |
| 10th order | 2.2642.E+00 | −4.3955.E+00 | 6.4032.E−01 | −3.7344.E−01 |
| coefficients | | | | |
| 12th order | −3.3154.E+00 | 4.5481.E+00 | −1.4686.E+00 | 2.3334.E−01 |
| coefficients | | | | |
| 14th order | 2.0887.E+00 | −2.2599.E+00 | 1.4146.E+00 | −9.0738.E−02 |
| coefficients | | | | |
| 16th order | −4.6618.E−01 | 4.2556.E−01 | −7.2347.E−01 | 2.1219.E−02 |
| coefficients | | | | |
| 18th order | 0.0000.E+00 | 0.0000.E+00 | 1.9285.E−01 | −2.6985.E−03 |
| coefficients | | | | |
| 20th order | 0.0000.E+00 | 0.0000.E+00 | −2.1143.E−02 | 1.4205.E−04 |
| coefficients | | | | |

In the notation of the aspherical surface, for example, “2.1143. E-02” means “2.1143*10-2”. The same applies to the other examples below.

The values of the parameters of each condition are as follows. Table 3 also describes the EP: incident pupil position.

TABLE 3

| Item | Number |
|---|---|
| f | 2.13 |
| Fno | 2.2 |
| OAL | 2.90 |
| IH | 2.305 |
| EfD1 | 0.95 |
| Half FOV | 45.00 |
| EP | 0.00 |
| EXP | −1.633 |
| f1 | 2.83 |
| f2 | −12.3 |
| f3 | 1.37 |
| f4 | −1.28 |
| N1 | 1.5365 |
| N2 | 1.6606 |
| N3 | 1.5365 |
| N4 | 1.6328 |

In addition to Conditional Expressions (1) to (11) and (16), (12) to (14) are also described as references in the table.

TABLE 4

| | Conditional | | | |
|---|---|---|---|---|
| | expression | Number | Lower limit | Upper limit |
| (1) | f/f1 | 0.753 | 0.45 | 0.80 |
| (2) | \|f4/f1\| | 0.452 | 0.25 | 0.50 |
| (3) | N1 < N4 | Refer to | | |
| | | Table 3 | | |
| (4) | N1 | 1.53650 | 1.49 | 1.55 |
| (5) | N4 | 1.63277 | 1.63 | 1.67 |
| (6) | f/OAL | 0.734 | 0.60 | 0.75 |
| (7) | OAL/EfD1 | 3.051 | 2.9 | 3.6 |
| (8) | EXP/IH | −0.708 | −0.94 | −0.70 |
| (9) | \|f1/f2\| | 0.230 | 0.01 | 0.40 |
| (10) | f3/f1 | 0.484 | 0.25 | 0.55 |
| (11) | \|f3/f4\| | 1.070 | 0.7 | 1.3 |
| (12) | \|f4/f2\| | 0.104 | 0.01 | 0.15 |
| (13) | \|f3/f2\| | 0.111 | 0.01 | 0.17 |
| (14) | OAL/2*IH | 0.629 | 0.61 | 0.65 |
| (16) | f/f2 | −0.173 | −0.2 | −0.0 |

The meanings of Conditional Expressions (12) to (14) are as follows.

$$01 < \vert f 4 / f 2 \vert < 0.15 \qquad ( 12 )$$

Regarding Conditional Expression (12), f2 represents the focal length of the second lens L2, and f4 represents the focal length of the fourth lens L4, and it is a condition for the balance of the focal lengths of the second lens L2 and the fourth lens L4. It is possible to achieve high performance within the range of Conditional Expression (12). In a case where the value is equal to or less than the lower limit of the conditional expression, the astigmatism increases, and in a case where the value is equal to or greater than the upper limit of Conditional Expression (12), the spherical aberration increases, and thus it is desirable to satisfy the range of the conditional expression.

$$01 < \vert f 3 / f 2 \vert < 0.17 \qquad ( 13 )$$

Regarding Conditional Expression (13), f2 represents the focal length of the second lens L2, and f3 represents the focal length of the third lens L3, and it is a condition for the balance of the focal lengths of the second lens L2 and the third lens L3.

It is possible to achieve high performance within the range of Conditional Expression (13). In a case where the value is equal to or less than the lower limit of Conditional Expression (13), the astigmatism increases, and in a case where the value is equal to or greater than the upper limit of Conditional Expression (13), the spherical aberration increases, and thus it is preferable to satisfy the range of the conditional expression.

In the present disclosure, although the power of the second lens L2 is weak compared to the power of the other lenses, in the present disclosure, by disposing a positive or negative lens having a relatively weak power compared to other lenses as the second lens L2, it is possible to effectively correct the astigmatism, the spherical aberration, and the distortion aberration.

$$0.61 < ORL / 2 * IH < 0 \text{.65} \qquad ( 14 )$$

Regarding Conditional Expression (14), OAL illustrates the optical overall length, IH illustrates the image height, the so-called image circle of the optical system, and it illustrates the ratio of the optical overall length to the image circle. As illustrated in Conditional Expression (14), the optical overall length with respect to the image circle is 0.61 to 0.65, and it is clear that the imaging lens 100 according to the present disclosure has a low height.

In addition, these Conditional Expressions (12) to (14) are also applied to Example 2 and subsequent examples.

In addition, in each example, aspherical surfaces are used from the first lens L1 to the fourth lens L4, and aberrations are effectively corrected by the aspherical surfaces.

The aberration diagram, the MTF, and the distortion grid related to Example 1 are illustrated in FIGS. 2A to 2C, and as is clear from each drawing, the performance is good.

### Example 2

f=1.9 mm, FNo.=2.0, HFOV=47°

Table 5 illustrates the data from Example 2.

TABLE 5

| No | R | D | Nd | Vd | SD | f |
|---|---|---|---|---|---|---|
| 1 | — | −0.05 | | | 0.48 | |
| 2 | 1.358 | 0.307 | 1.5094 | 56.47 | 0.54 | 3.5 |
| 3 | 4.981 | 0.355 | | | 0.61 | |
| 4 | 2.428 | 0.200 | 1.6328 | 23.29 | 0.72 | −29.9 |
| 5 | 2.086 | 0.145 | | | 0.88 | |
| 6 | −5.917 | 0.864 | 1.5094 | 56.47 | 1.00 | 1.1 |
| 7 | −0.557 | 0.145 | | | 1.11 | |
| 8 | 0.860 | 0.200 | 1.6328 | 23.29 | 1.45 | −1.2 |
| 9 | 0.374 | 0.524 | | | 1.92 | |
| 10 | — | 0.11 | 1.52 | 64.20 | 2.13 | — |
| 11 | — | 0.1 | | | 2.17 | |
| 12 | — | — | | | | |

The aspherical data is illustrated below.

TABLE 6

| | 2 | 3 | 4 | 5 |
|---|---|---|---|---|
| Conic | −1.3334.E+00 | 4.4808.E+01 | −1.6768.E+01 | −8.1635.E+00 |
| constant (k) | | | | |
| 4th order | 7.7911.E−02 | −1.8325.E−01 | −3.2398.E−01 | −1.8715.E−01 |
| coefficients | | | | |
| 6th order | −1.7625.E+00 | 6.6650.E−01 | −1.5592.E−01 | −5.7471.E−02 |
| coefficients | | | | |
| 8th order | 2.2885.E+01 | −1.2016.E+01 | −1.5121.E−01 | 1.7959.E−02 |
| coefficients | | | | |
| 10th order | −1.6707.E+02 | 7.9160.E+01 | −5.6575.E−01 | 5.4252.E−02 |
| coefficients | | | | |
| 12th order | 6.4911.E+02 | −2.9856.E+02 | −4.1170.E−01 | 6.6646.E−02 |
| coefficients | | | | |
| 14th order | −1.2754.E+03 | 5.7423.E+02 | 6.6008.E−01 | 3.8489.E−02 |
| coefficients | | | | |
| 16th order | 9.5139.E+02 | −4.6024.E+02 | 0.0000.E+00 | 0.0000.E+00 |
| coefficients | | | | |
| | 6 | 7 | 8 | 9 |
| Conic | 1.9033.E+01 | −3.1836.E+00 | −1.0977.E+01 | −3.4979.E+00 |
| constant (k) | | | | |
| 4th order | 5.4983.E−02 | −1.3809.E−01 | −2.1851.E−01 | −2.0914.E−01 |
| coefficients | | | | |
| 6th order | −9.2455.E−02 | −6.3693.E−01 | 4.8488.E−02 | 1.3490.E−01 |
| coefficients | | | | |
| 8th order | −4.5565.E−01 | 2.3669.E+00 | −2.3369.E−01 | −9.0343.E−02 |
| coefficients | | | | |
| 10th order | 2.2758.E+00 | −4.4479.E+00 | 4.4453.E−01 | 6.0392.E−02 |
| coefficients | | | | |
| 12th order | −3.2864.E+00 | 4.5254.E+00 | −3.4105.E−01 | −2.7075.E−02 |
| coefficients | | | | |
| 14th order | 2.0845.E+00 | −2.2631.E+00 | 1.1922.E−01 | 6.0925.E−03 |
| coefficients | | | | |
| 16th order | −5.0341.E−01 | 4.4324.E−01 | −1.5848.E−02 | −5.2148.E−04 |
| coefficients | | | | |

The values of the parameters of each condition are as follows.

TABLE 7

| Item | Number |
|---|---|
| f | 1.94 |
| Fno | 2.0 |
| OAL | 2.90 |
| IH | 2.305 |
| EfD1 | 0.967 |
| Half FOV | 47.31 |
| EP | 0.00 |
| EXP | −1.95 |
| f1 | 3.55 |
| f2 | −29.94 |
| f3 | 1.14 |
| f4 | −1.23 |
| N1 | 1.5094 |
| N2 | 1.6328 |
| N3 | 1.5094 |
| N4 | 1.6328 |

TABLE 8

| | Conditional | | | |
|---|---|---|---|---|
| | expression | Number | Lower limit | Upper limit |
| (1) | f/f1 | 0.545 | 0.45 | 0.80 |
| (2) | \|f4/f1\| | 0.348 | 0.25 | 0.50 |
| (3) | N1 < N4 | Refer to | | |
| | | Table 7 | | |
| (4) | N1 | 1.5094 | 1.49 | 1.55 |
| (5) | N4 | 1.6328 | 1.63 | 1.67 |
| (6) | f/OAL | 0.667 | 0.60 | 0.75 |
| (7) | OAL/EfD1 | 2.998 | 2.9 | 3.6 |
| (8) | EXP/IH | −0.846 | −0.94 | −0.70 |
| (9) | \|f1/f2\| | 0.119 | 0.01 | 0.40 |
| (10) | f3/f1 | 0.321 | 0.25 | 0.55 |
| (11) | \|f3/f4\| | 0.923 | 0.7 | 1.3 |
| (12) | \|f4/f2\| | 0.041 | 0.01 | 0.15 |
| (13) | \|f3/f2\| | 0.038 | 0.01 | 0.17 |
| (14) | OAL/2*IH | 0.629 | 0.61 | 0.65 |
| (16) | f/f2 | −0.065 | −0.2 | −0.0 |

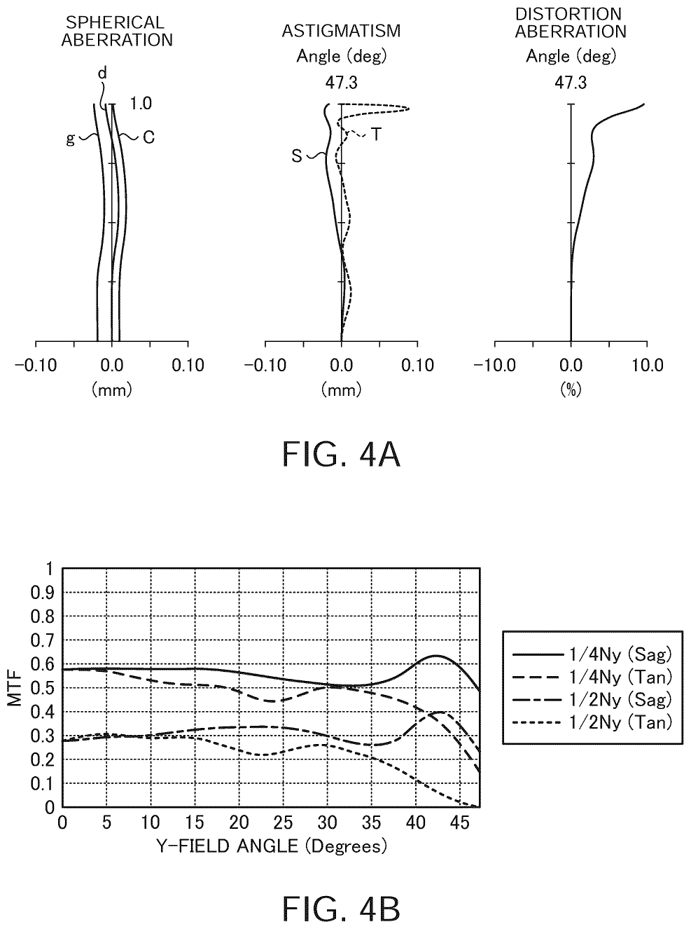

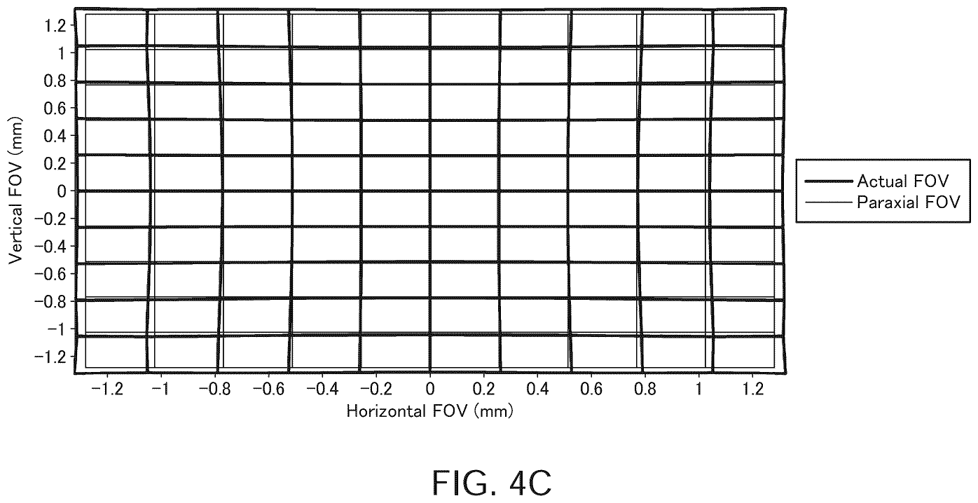

These aberration diagrams, MTFs, and distortion grids are illustrated in FIGS. 4A to 4C, and as is clear from each drawing, the performance is good.

### Example 3

f=1.8 mm, FNo.=2.2, HFOV=51°

Table 9 illustrates the data from Example 3.

TABLE 9

| No | R | D | Nd | Vd | SD | f |
|---|---|---|---|---|---|---|
| 1 | — | −0.05 | | | 0.40 | |
| 2 | 1.355 | 0.252 | 1.5365 | 55.98 | 0.43 | 3.7 |
| 3 | 3.968 | 0.296 | | | 0.50 | |
| 4 | 4.972 | 0.165 | 1.6328 | 23.29 | 0.60 | −9.9 |
| 5 | 2.750 | 0.050 | | | 0.79 | |
| 6 | −6.937 | 1.046 | 1.5365 | 55.98 | 0.90 | 1.0 |
| 7 | −0.512 | 0.137 | | | 1.06 | |
| 8 | 0.646 | 0.165 | 1.6328 | 23.29 | 1.37 | −1.2 |
| 9 | 0.314 | 0.567 | | | 1.86 | |
| 10 | — | 0.11 | 1.52 | 64.20 | 2.09 | — |
| 11 | — | 0.162 | | | 2.14 | |
| 12 | — | — | | | | |

The aspherical data is illustrated below.

TABLE 10

| | 2 | 3 | 4 | 5 |
|---|---|---|---|---|
| Conic | −8.3662.E−01 | 2.7230.E+01 | −1.6572.E+02 | −4.5131.E+01 |
| constant (k) | | | | |
| 4th order | 6.1119.E−02 | −1.6229.E−01 | −6.3520.E−01 | −2.5457.E−01 |
| coefficients | | | | |
| 6th order | −4.4194.E−01 | −2.9009.E−01 | −4.6937.E−01 | −8.6354.E−02 |
| coefficients | | | | |
| 8th order | 2.1254.E+00 | −2.1041.E−01 | −2.5032.E−01 | 6.2974.E−02 |
| coefficients | | | | |
| 10th order | −7.0336.E+00 | −4.1766.E+00 | −2.9009.E+00 | 1.6307.E−01 |
| coefficients | | | | |
| 12th order | 3.6680.E−01 | −1.6132.E+00 | −1.2856.E+00 | 1.6644.E−01 |
| coefficients | | | | |
| 14th order | −1.7969.E−03 | −3.8351.E+00 | −3.4796.E+00 | 5.6885.E−02 |
| coefficients | | | | |
| | 6 | 7 | 8 | 9 |
| Conic | 1.5122.E+01 | −2.9430.E+00 | −9.2698.E+00 | −3.1886.E+00 |
| constant (k) | | | | |
| 4th order | 6.4355.E−02 | −2.8079.E−01 | −8.7167.E−02 | −1.8976.E−01 |
| coefficients | | | | |
| 6th order | 5.7003.E−03 | 2.7332.E−02 | −2.7077.E−01 | 7.1489.E−02 |
| coefficients | | | | |
| 8th order | 1.1917.E−02 | −9.6512.E−03 | 2.2151.E−01 | −1.6016.E−02 |
| coefficients | | | | |
| 10th order | −1.4560.E−02 | −2.6918.E−02 | −5.7884.E−02 | 1.1686.E−03 |
| coefficients | | | | |
| 12th order | −1.4227.E−02 | 3.7820.E−03 | 0.0000.E+00 | 0.0000.E+00 |
| coefficients | | | | |
| 14th order | 1.2258.E−02 | 2.6854.E−02 | 0.0000.E+00 | 0.0000.E+00 |
| coefficients | | | | |

The values of the parameters of each condition are as follows.

TABLE 11

| Item | Number |
|---|---|
| f | 1.78 |
| Fno | 2.2 |
| OAL | 2.90 |
| IH | 2.31 |
| EfD1 | 0.81 |
| Half FOV | 51.43 |
| EP | 0.00 |
| EXP | −2.14 |
| f1 | 3.70 |
| f2 | −9.91 |
| f3 | 0.97 |
| f4 | −1.19 |
| N1 | 1.5365 |
| N2 | 1.6328 |
| N3 | 1.5365 |
| N4 | 1.6328 |

TABLE 12

| | Conditional | | | |
|---|---|---|---|---|
| | expression | Number | Lower limit | Upper limit |
| (1) | f/f1 | 0.482 | 0.45 | 0.80 |
| (2) | \|f4/f1\| | 0.321 | 0.25 | 0.50 |
| (3) | N1 < N4 | Refer to | | |
| | | Table 11 | | |
| (4) | N1 | 1.5365 | 1.49 | 1.55 |
| (5) | N4 | 1.6328 | 1.63 | 1.67 |
| (6) | f/OAL | 0.614 | 0.60 | 0.75 |
| (7) | OAL/EfD1 | 3.584 | 2.9 | 3.6 |
| (8) | EXP/IH | −0.926 | −0.94 | −0.70 |
| (9) | \|f1/f2\| | 0.373 | 0.01 | 0.40 |
| (10) | f3/f1 | 0.263 | 0.25 | 0.55 |
| (11) | \|f3/f4\| | 0.819 | 0.7 | 1.3 |
| (12) | \|f4/f2\| | 0.120 | 0.01 | 0.15 |
| (13) | \|f3/f2\| | 0.098 | 0.01 | 0.17 |
| (14) | OAL/2*IH | 0.629 | 0.61 | 0.65 |
| (16) | f/f2 | −0.180 | −0.2 | −0.0 |

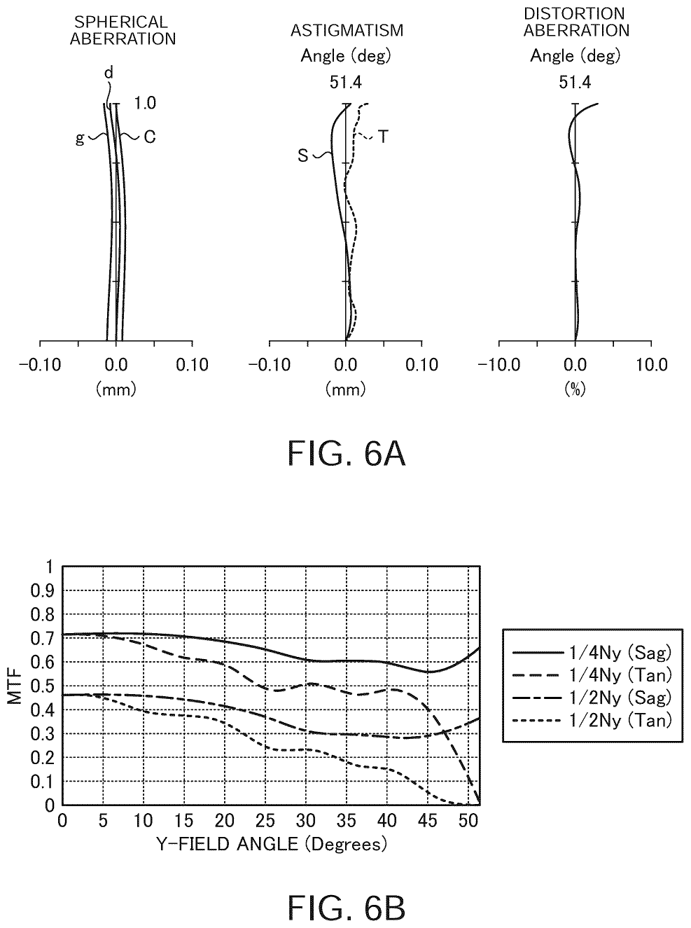

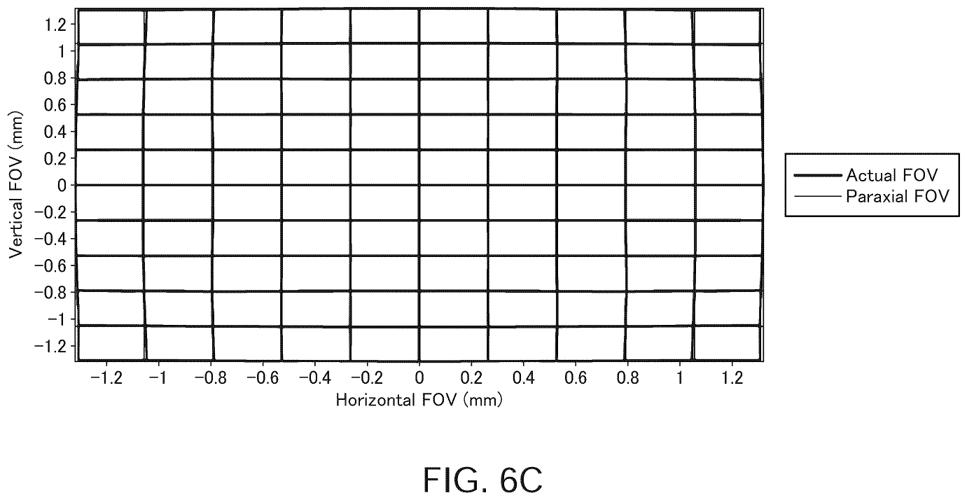

These aberration diagrams, MTFs, and distortion grids are illustrated in FIGS. 6A to 6C, and as is clear from each drawing, the performance is good.

### Example 4

f=1.9 mm, FNo.=2.0, HFOV=48°

Table 13 illustrates the data from Example 4.

TABLE 13

| No | R | D | Nd | Vd | SD | f |
|---|---|---|---|---|---|---|
| 1 | — | −0.07 | | | 0.48 | |
| 2 | 1.424 | 0.340 | 1.5365 | 55.98 | 0.50 | 3.7 |
| 3 | 4.685 | 0.334 | | | 0.59 | |
| 4 | 2.638 | 0.220 | 1.6422 | 22.41 | 0.71 | −32.8 |
| 5 | 2.270 | 0.100 | | | 0.89 | |
| 6 | −5.152 | 0.839 | 1.5365 | 55.98 | 0.94 | 1.3 |
| 7 | −0.666 | 0.334 | | | 1.06 | |
| 8 | 1.098 | 0.165 | 1.6422 | 22.41 | 1.35 | −1.5 |
| 9 | 0.483 | 0.428 | | | 1.83 | |
| 10 | — | 0.11 | 1.52 | 64.20 | 2.13 | — |
| 11 | — | 0.1 | | | 2.17 | |
| 12 | — | — | | | | |

The aspherical data is illustrated below.

TABLE 14

| | 2 | 3 | 4 | 5 |
|---|---|---|---|---|
| Conic | −9.2278.E−01 | 4.4614.E+01 | −1.3152.E+01 | −7.6832.E+00 |
| constant (k) | | | | |
| 4th order | 5.1755.E−02 | −1.3081.E−01 | −3.4294.E−01 | −1.7342.E−01 |
| coefficients | | | | |
| 6th order | −4.6826.E−01 | −1.5853.E−01 | −1.9644.E−01 | −5.6856.E−02 |
| coefficients | | | | |
| 8th order | 2.1188.E+00 | −4.3487.E−01 | −1.0998.E−01 | −7.8990.E−03 |
| coefficients | | | | |
| 10th order | −4.5518.E+00 | 2.7639.E−01 | −3.9324.E−01 | 2.0139.E−02 |
| coefficients | | | | |
| 12th order | 3.6680.E−01 | −1.6132.E+00 | −4.7198.E−01 | 4.8359.E−02 |
| coefficients | | | | |
| 14th order | −1.7965.E−03 | −3.8351.E+00 | 1.4363.E−02 | 5.7735.E−02 |
| coefficients | | | | |
| | 6 | 7 | 8 | 9 |
| Conic | 1.7121.E+01 | −2.8135.E+00 | −2.3077.E+01 | −4.0615.E+00 |
| constant (k) | | | | |
| 4th order | 3.2843.E−02 | −1.9899.E−01 | −1.6240.E−01 | −1.8064.E−01 |
| coefficients | | | | |
| 6th order | 1.3639.E−02 | 6.1575.E−03 | −1.9436.E−01 | 7.6720.E−02 |
| coefficients | | | | |
| 8th order | 4.6200.E−02 | 1.4285.E−02 | 2.3013.E−01 | −1.8526.E−02 |
| coefficients | | | | |
| 10th order | 2.2887.E−02 | 3.4760.E−03 | −7.2944.E−02 | 4.2530.E−04 |
| coefficients | | | | |
| 12th order | −1.6944.E−04 | 1.2689.E−02 | 1.4898.E−03 | 4.3340.E−04 |
| coefficients | | | | |
| 14th order | −1.4581.E−02 | 2.0301.E−02 | −1.4355.E−03 | −7.6744.E−05 |
| coefficients | | | | |

The values of the parameters of each condition are as follows.

TABLE 15

| Item | Number |
|---|---|
| f | 1.93 |
| Fno | 2.0 |
| OAL | 2.90 |
| IH | 2.305 |
| EfD1 | 0.966 |
| Half FOV | 47.56 |
| EP | 0.00 |
| EXP | −1.81 |
| f1 | 3.66 |
| f2 | −32.79 |
| f3 | 1.33 |
| f4 | −1.49 |
| N1 | 1.5365 |
| N2 | 1.6422 |
| N3 | 1.5365 |
| N4 | 1.6422 |

TABLE 16

| | Conditional | | | |
|---|---|---|---|---|
| | expression | Number | Lower limit | Upper limit |
| (1) | f/f1 | 0.527 | 0.45 | 0.80 |
| (2) | \|f4/f1\| | 0.406 | 0.25 | 0.50 |
| (3) | N1 < N4 | Refer to | | |
| | | Table 15 | | |
| (4) | N1 | 1.5365 | 1.49 | 1.55 |
| (5) | N4 | 1.6422 | 1.63 | 1.67 |
| (6) | F/OAL | 0.666 | 0.60 | 0.75 |
| (7) | OAL/EfD1 | 3.004 | 2.9 | 3.6 |
| (8) | EXP/IH | −0.785 | −0.94 | −0.70 |
| (9) | \|f1/f2\| | 0.112 | 0.01 | 0.40 |
| (10) | f3/f1 | 0.364 | 0.25 | 0.55 |
| (11) | \|f3/f4\| | 0.896 | 0.7 | 1.3 |
| (12) | \|f4/f2\| | 0.045 | 0.01 | 0.15 |
| (13) | \|f3/f2\| | 0.041 | 0.01 | 0.17 |
| (14) | OAL/2*IH | 0.629 | 0.61 | 0.65 |
| (16) | f/f2 | −0.059 | −0.2 | −0.0 |

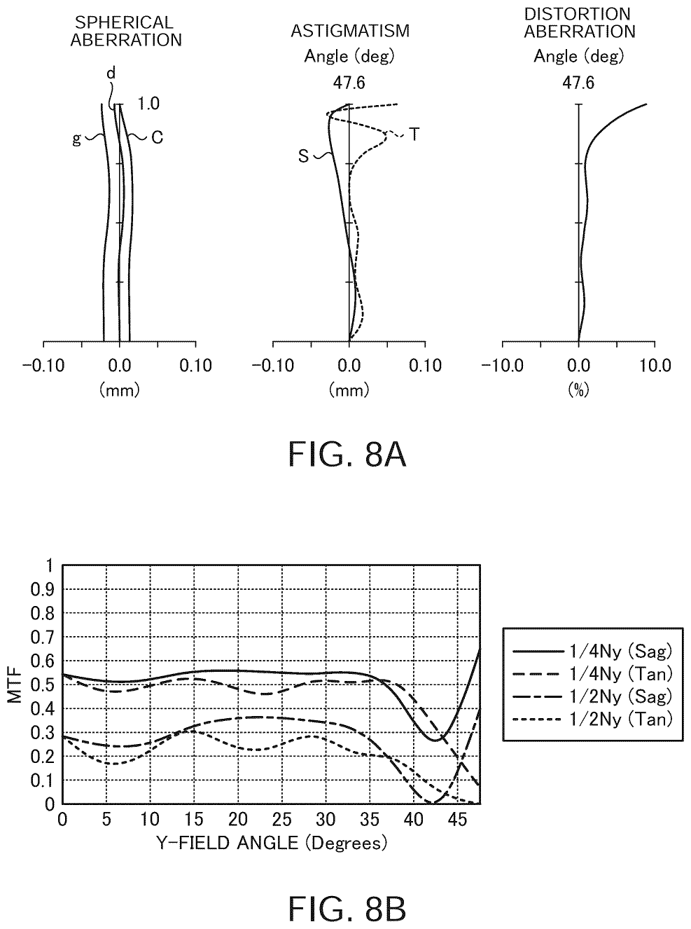

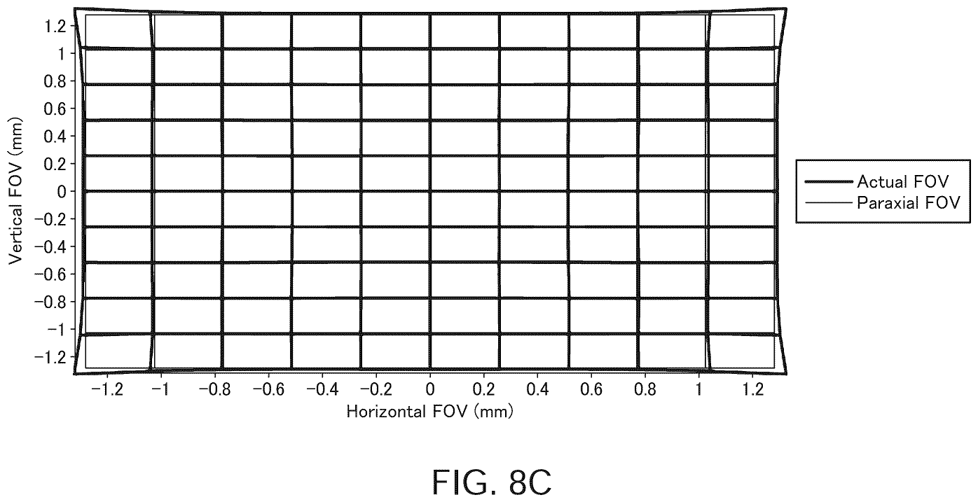

These aberration diagrams, MTFs, and distortion grids are illustrated in FIGS. 8A to 8C, and as is clear from each aberration diagram, the performance is good.

### Example 5

f=1.9 mm, FNo.=2.0, HFOV=48°

Table 17 illustrates the data from Example 5.

TABLE 17

| No | R | D | Nd | Vd | SD | f |
|---|---|---|---|---|---|---|
| 1 | — | −0.07 | | | 0.48 | |
| 2 | 1.257 | 0.295 | 1.5168 | 64.20 | 0.54 | 3.5 |
| 3 | 3.792 | 0.354 | | | 0.59 | |
| 4 | 4.114 | 0.200 | 1.6422 | 22.41 | 0.68 | −16.2 |
| 5 | 2.902 | 0.100 | | | 0.86 | |
| 6 | −5.259 | 0.871 | 1.5365 | 55.98 | 0.97 | 1.3 |
| 7 | −0.660 | 0.328 | | | 1.08 | |
| 8 | 0.979 | 0.165 | 1.6422 | 22.41 | 1.44 | −1.5 |
| 9 | 0.458 | 0.447 | | | 1.89 | |
| 10 | — | 0.11 | 1.52 | 64.20 | 2.14 | — |
| 11 | — | 0.1 | | | 2.18 | |
| 12 | — | — | | | | |

The aspherical data is illustrated below.

TABLE 18

| | 2 | 3 | 4 | 5 |
|---|---|---|---|---|
| Conic | −4.1863.E−01 | 3.1517.E+01 | −3.1986.E+01 | −1.8877.E+01 |
| constant (k) | | | | |
| 4th order | 1.0106.E−01 | −5.8794.E−02 | −4.1225.E−01 | −1.9207.E−01 |
| coefficients | | | | |
| 6th order | −1.4225.E+00 | −8.2304.E−01 | −3.0401.E−01 | −6.0937.E−02 |
| coefficients | | | | |
| 8th order | 1.6643.E+01 | 6.3861.E+00 | −1.2709.E−01 | 4.1373.E−03 |
| coefficients | | | | |
| 10th order | −1.0136.E+02 | −3.5996.E+01 | −3.2547.E−01 | 4.9514.E−02 |
| coefficients | | | | |
| 12th order | 3.0415.E+02 | 9.5141.E+01 | −8.8406.E−01 | 8.3214.E−02 |
| coefficients | | | | |
| 14th order | −3.6035.E+02 | −1.0746.E+02 | 1.4363.E−02 | 1.0510.E−01 |
| coefficients | | | | |
| | 6 | 7 | 8 | 9 |
| Conic | 1.7435.E+01 | −2.6222.E+00 | −1.8470.E+01 | −3.8914.E+00 |
| constant (k) | | | | |
| 4th order | 1.5156.E−02 | −1.9900.E−01 | −2.0307.E−01 | −1.9560.E−01 |
| coefficients | | | | |
| 6th order | 1.6935.E−02 | −4.4355.E−03 | −1.2533.E−01 | 9.4239.E−02 |
| coefficients | | | | |
| 8th order | 5.1543.E−02 | 1.1491.E−03 | 2.0374.E−01 | −2.2936.E−02 |
| coefficients | | | | |
| 10th order | 2.1539.E−02 | 3.2100.E−03 | −8.3183.E−02 | −4.0682.E−04 |
| coefficients | | | | |
| 12th order | −5.0202.E−03 | 1.3271.E−02 | 4.5309.E−03 | 8.4907.E−04 |
| coefficients | | | | |
| 14th order | −1.2644.E−02 | 2.0884.E−02 | 2.0193.E−03 | −9.0538.E−05 |
| coefficients | | | | |

The values of the parameters of each condition are as follows.

TABLE 19

| Item | Number |
|---|---|
| f | 1.93 |
| Fno | 2.0 |
| OAL | 2.90 |
| IH | 2.30 |
| EfD1 | 0.962 |
| Half FOV | 47.56 |
| EP | 0.00 |
| EXP | −1.87 |
| f1 | 3.49 |
| f2 | −16.24 |
| f3 | 1.31 |
| f4 | −1.51 |
| N1 | 1.5168 |
| N2 | 1.6422 |
| N3 | 1.5365 |
| N4 | 1.6422 |

TABLE 20

| | Conditional | | | |
|---|---|---|---|---|
| | expression | Number | Lower limit | Upper limit |
| (1) | f/f1 | 0.552 | 0.45 | 0.80 |
| (2) | \|f4/f1\| | 0.434 | 0.25 | 0.50 |
| (3) | N1 < N4 | Refer to | | |
| | | Table 19 | | |
| (4) | N1 | 1.5168 | 1.49 | 1.55 |
| (5) | NA | 1.6422 | 1.63 | 1.67 |
| (6) | f/OAL | 0.664 | 0.60 | 0.75 |
| (7) | OAL/EfD1 | 3.013 | 2.9 | 3.6 |
| (8) | EXP/IH | −0.815 | −0.94 | −0.70 |
| (9) | \|f1/f2\| | 0.215 | 0.01 | 0.40 |
| (10) | f3/f1 | 0.376 | 0.25 | 0.55 |
| (11) | \|f3/f4\| | 0.867 | 0.7 | 1.3 |
| (12) | \|f4/f2\| | 0.093 | 0.01 | 0.15 |
| (13) | \|f3/f2\| | 0.081 | 0.01 | 0.17 |
| (14) | OAL/2*IH | 0.632 | 0.61 | 0.65 |
| (16) | f/f2 | −0.119 | −0.2 | −0.0 |

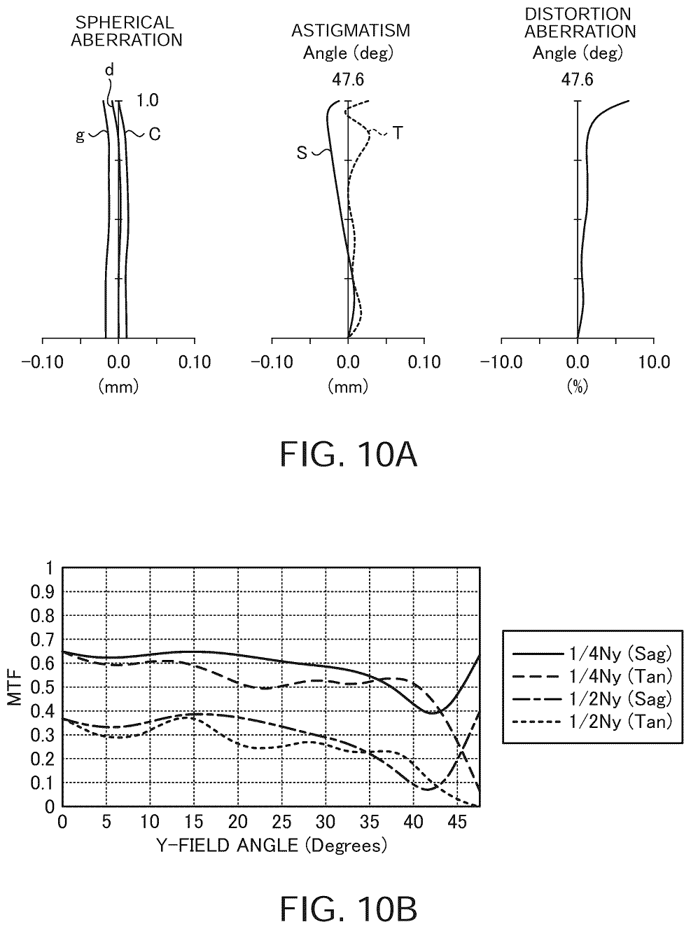

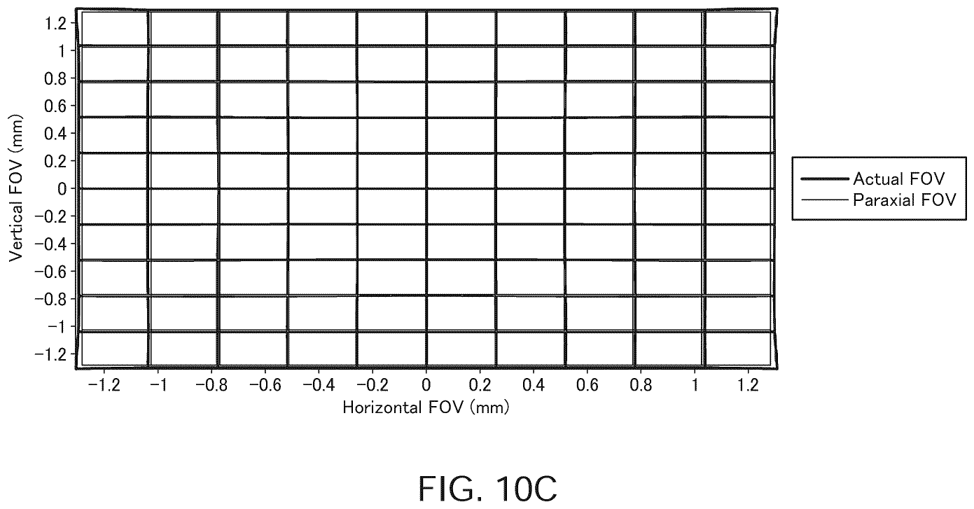

These aberration diagrams, MTFs, and distortion grids are illustrated in FIGS. 10A to 10C, and as is clear from each aberration diagram, the performance is good.

### Example 6

f=2.0 mm, FNo.=2.2, HFOV=48°

Table 21 illustrates the data from Example 6.

TABLE 21

| No | R | D | Nd | Vd | SD | f |
|---|---|---|---|---|---|---|
| 1 | — | −0.08 | | | 0.45 | |
| 2 | 1.175 | 0.272 | 1.5365 | 55.98 | 0.47 | 3.4 |
| 3 | 3.081 | 0.312 | | | 0.53 | |
| 4 | 4.314 | 0.209 | 1.6328 | 23.29 | 0.61 | 16.3 |
| 5 | 7.211 | 0.111 | | | 0.77 | |
| 6 | −1.836 | 0.759 | 1.5365 | 55.98 | 0.93 | 1.4 |
| 7 | −0.615 | 0.100 | | | 1.04 | |
| 8 | 2.546 | 0.412 | 1.6652 | 29.43 | 1.20 | −1.4 |
| 9 | 0.654 | 0.163 | | | 1.77 | |
| 10 | — | 0.11 | 1.52 | 64.20 | 2.13 | — |
| 11 | — | 0.13 | | | 2.17 | |
| 12 | — | — | | | | |

The aspherical data is illustrated below.

TABLE 22

| | 2 | 3 | 4 | 5 |
|---|---|---|---|---|
| Conic | −8.5715.E−01 | 2.4391.E+01 | −8.8185.E+00 | 2.2895.E+01 |
| constant(k) | | | | |
| 4th order | 6.8995.E−02 | −1.9649.E−01 | −4.3111.E−01 | −1.2364.E−01 |
| coefficients | | | | |
| 6th order | −3.0521.E−01 | −3.7827.E−01 | −7.7466.E−01 | −3.7248.E−01 |
| coefficients | | | | |
| 8th order | 1.4029.E+00 | −1.1814.E+00 | −3.4611.E−01 | −5.5228.E−02 |
| coefficients | | | | |
| 10th order | −3.9610.E+00 | −9.2382.E−01 | −3.2376.E−01 | 3.9617.E−01 |
| coefficients | | | | |
| 12th order | −4.4192.E+00 | 2.3541.E+00 | −5.5258.E+00 | 7.3270.E−01 |
| coefficients | | | | |
| 14th order | 5.1998.E+00 | −3.5003.E+01 | 1.1751.E+00 | −1.2132.E−01 |
| coefficients | | | | |
| 16th order | 0.0000.E+00 | 0.0000.E+00 | 0.0000.E+00 | 0.0000.E+00 |
| coefficients | | | | |
| | 6 | 7 | 8 | 9 |
| Conic | −5.3015.E+00 | −3.1484.E+00 | −1.4327.E+01 | −5.0134.E+00 |
| constant(k) | | | | |
| 4th order | 1.5291.E−01 | −2.6840.E−01 | −2.0163.E−01 | −1.7569.E−01 |
| coefficients | | | | |
| 6th order | 1.0144.E−01 | 6.6151.E−02 | −2.1087.E−01 | 8.1675.E−02 |
| coefficients | | | | |
| 8th order | 1.7144.E−03 | 7.2603.E−02 | 3.6503.E−01 | −2.3746.E−02 |
| coefficients | | | | |
| 10th order | −8.9984.E−02 | 6.8368.E−03 | −2.3336.E−01 | 4.0780.E−04 |
| coefficients | | | | |
| 12th order | −5.6339.E−02 | 1.6298.E−03 | 1.7364.E−02 | 5.5409.E−04 |
| coefficients | | | | |
| 14th order | 6.6985.E−02 | −1.0836.E−02 | 2.1616.E−02 | 1.3557.E−04 |
| coefficients | | | | |
| 16th order | 0.0000.E+00 | 0.0000.E+00 | −3.7396.E−03 | −4.3955.E−05 |
| coefficients | | | | |

The values of the parameters of each condition are as follows.

TABLE 23

| Item | Number |
|---|---|
| f | 2.03 |
| Fno | 2.2 |
| OAL | 2.90 |
| IH | 2.31 |
| EfD1 | 0.908 |
| Half FOV | 47.90 |
| EP | 0.00 |
| EXP | −1.84 |
| f1 | 3.36 |
| f2 | 16.34 |
| f3 | 1.41 |
| f4 | −1.45 |
| N1 | 1.5365 |
| N2 | 1.6328 |
| N3 | 1.5365 |
| N4 | 1.6652 |

TABLE 24

| | Conditional | | | |
|---|---|---|---|---|
| | expression | Number | Lower limit | Upper limit |
| (1) | f/f1 | 0.606 | 0.45 | 0.80 |
| (2) | \|f4/f1\| | 0.432 | 0.25 | 0.50 |
| (3) | N1 < N4 | Refer to | | |
| | | Table 23 | | |
| (4) | N1 | 1.5365 | 1.49 | 1.55 |
| (5) | N4 | 1.6652 | 1.63 | 1.67 |
| (6) | f/OAL | 0.701 | 0.60 | 0.75 |
| (7) | OAL/EfD1 | 3.194 | 2.9 | 3.6 |
| (8) | EXP/IH | −0.796 | −0.94 | −0.70 |
| (9) | \|f1/f2\| | 0.205 | 0.01 | 0.40 |
| (10) | f3/f1 | 0.420 | 0.25 | 0.55 |
| (11) | \|f3/f4\| | 0.972 | 0.7 | 1.3 |
| (12) | \|f4/f2\| | 0.089 | 0.01 | 0.15 |
| (13) | \|f3/f2\| | 0.086 | 0.01 | 0.17 |
| (14) | OAL/2*IH | 0.629 | 0.61 | 0.65 |
| (17) | f/f2 | 0.124 | 0.01 | 0.25 |

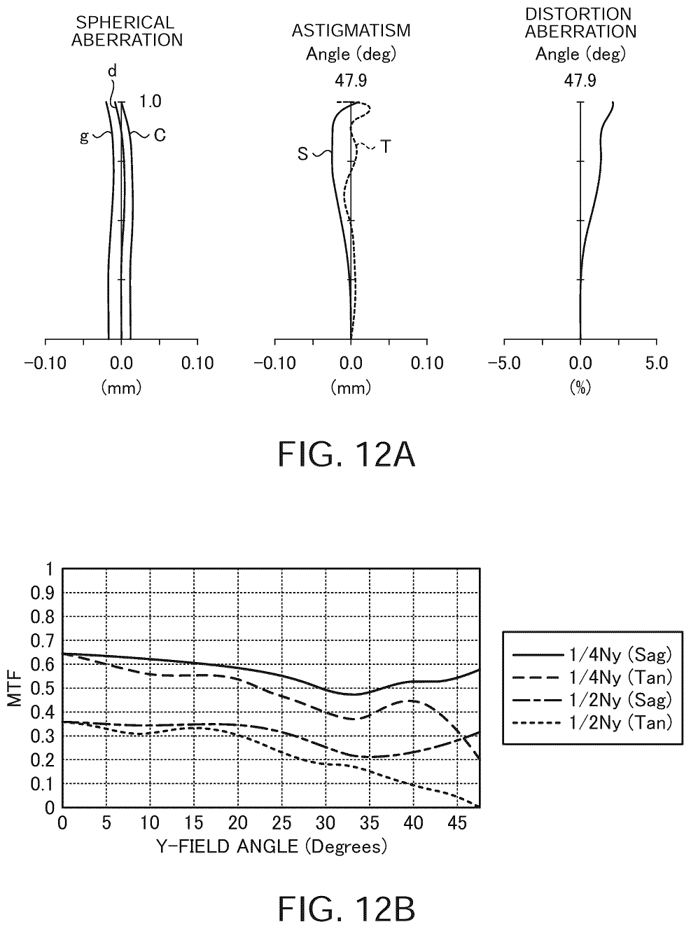

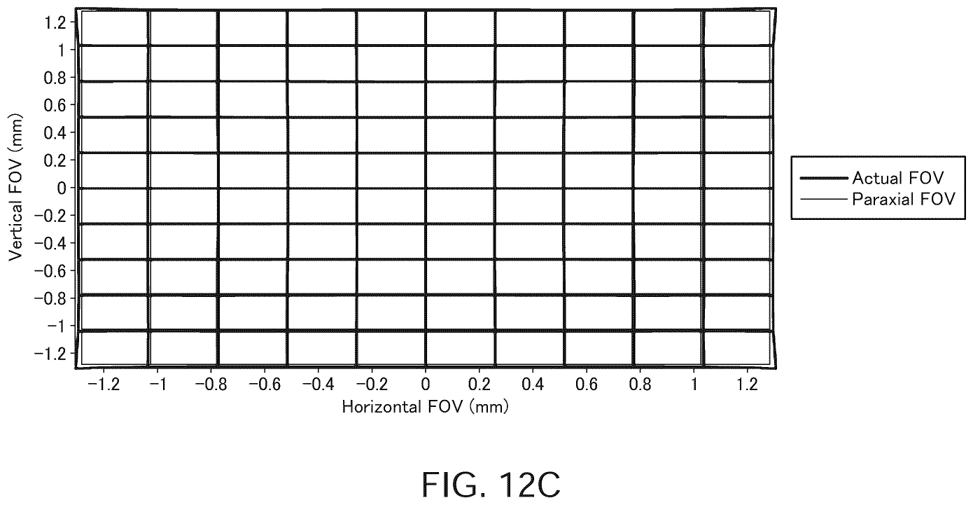

These aberration diagrams, MTFs, and distortion grids are illustrated in FIGS. 12A to 12C, and as is clear from each aberration diagram, the performance is good.

### Example 7

f=2.0 mm, FNo.=2.2, HFOV=48°

Table 25 illustrates the data from Example 7.

TABLE 25

| No | R | D | Nd | Vd | SD | f |
|---|---|---|---|---|---|---|
| 1 | — | −0.07 | | | 0.45 | |
| 2 | 1.206 | 0.278 | 1.5365 | 55.98 | 0.48 | 3.4 |
| 3 | 3.273 | 0.310 | | | 0.54 | |
| 4 | 4.693 | 0.200 | 1.6328 | 23.29 | 0.61 | 97.3 |
| 5 | 4.992 | 0.111 | | | 0.78 | |
| 6 | −2.557 | 0.864 | 1.5365 | 55.98 | 0.96 | 0.9 |
| 7 | −0.467 | 0.100 | | | 1.06 | |
| 8 | 2.484 | 0.261 | 1.6328 | 23.29 | 1.22 | −0.9 |
| 9 | 0.453 | 0.587 | | | 1.75 | |
| 10 | — | 0.11 | 1.52 | 64.20 | 2.12 | — |
| 11 | — | 0.146 | | | 2.16 | |
| 12 | — | — | | | | |

The aspherical data is illustrated below.

TABLE 26

| | 2 | 3 | 4 | 5 |
|---|---|---|---|---|
| Conic | −9.2323.E−01 | 2.7202.E+01 | −3.6173.E+01 | −9.0152.E+00 |
| constant(k) | | | | |
| 4th order | 6.5009.E−02 | −2.0365.E−01 | −4.7167.E−01 | −2.0378.E−01 |
| coefficients | | | | |
| 6th order | −3.2022.E−01 | −3.3946.E−01 | −7.4952.E−01 | −2.3987.E−01 |
| coefficients | | | | |
| 8th order | 1.7085.E+00 | −1.2512.E+00 | 5.6942.E−02 | −3.6171.E−03 |
| coefficients | | | | |
| 10th order | −5.3124.E+00 | −6.0688.E−01 | −9.2364.E−01 | 3.2396.E−01 |
| coefficients | | | | |
| 12th order | −4.4192.E+00 | 2.3541.E+00 | −5.5258.E+00 | 5.5135.E−01 |
| coefficients | | | | |
| 14th order | 1.0682.E+01 | −3.5003.E+01 | 1.1751.E+00 | −1.1109.E−01 |
| coefficients | | | | |
| 16th order | 0.0000.E+00 | 0.0000.E+00 | 0.0000.E+00 | 0.0000.E+00 |
| coefficients | | | | |
| | 6 | 7 | 8 | 9 |
| Conic | −7.7506.E+00 | −3.4908.E+00 | −2.2418.E+01 | −4.7876.E+00 |
| constant(k) | | | | |
| 4th order | 9.4346.E−02 | −3.1925.E−01 | −1.6456.E−01 | −1.8814.E−01 |
| coefficients | | | | |
| 6th order | 7.6691.E−02 | 1.1099.E−01 | −2.9399.E−01 | 8.2304.E−02 |
| coefficients | | | | |
| 8th order | 2.9442.E−02 | 4.1721.E−02 | 4.0082.E−01 | −2.1745.E−02 |
| coefficients | | | | |
| 10th order | −6.1038.E−02 | −2.0776.E−02 | −2.0311.E−01 | 4.0715.E−04 |
| coefficients | | | | |
| 12th order | −5.6678.E−02 | 2.4094.E−03 | 9.3524.E−03 | 3.4935.E−04 |
| coefficients | | | | |
| 14th order | 5.4020.E−02 | 1.1507.E−02 | 1.1224.E−02 | 1.1375.E−04 |
| coefficients | | | | |
| 16th order | 0.0000.E+00 | 0.0000.E+00 | −2.1704.E−03 | −3.4783.E−05 |
| coefficients | | | | |

The values of the parameters of each condition are as follows.

TABLE 27

| Item | Number |
|---|---|
| f | 2.03 |
| Fno | 2.2 |
| OAL | 2.90 |
| IH | 2.304 |
| EfD1 | 0.904 |
| Half FOV | 47.97 |
| EP | 0.00 |
| EXP | −1.86 |
| f1 | 3.38 |
| f2 | 97.3 |
| f3 | 0.93 |
| f4 | −0.91 |
| N1 | 1.5365 |
| N2 | 1.6328 |
| N3 | 1.5365 |
| N4 | 1.6328 |

TABLE 28

| | Conditional | | | |
|---|---|---|---|---|
| | expression | Number | Lower limit | Upper limit |
| (1) | f/f1 | 0.599 | 0.45 | 0.80 |
| (2) | \|f4/f1\| | 0.270 | 0.25 | 0.50 |
| (3) | N1 < N4 | Refer to | | |
| | | Table 27 | | |
| (4) | N1 | 1.5365 | 1.49 | 1.55 |
| (5) | N4 | 1.6328 | 1.63 | 1.67 |
| (6) | f/OAL | 0.699 | 0.60 | 0.75 |
| (7) | OAL/EfD1 | 3.207 | 2.9 | 3.6 |
| (8) | EXP/IH | −0.808 | −0.94 | −0.70 |
| (9) | \|f1/f2\| | 0.035 | 0.01 | 0.40 |
| (10) | f3/f1 | 0.274 | 0.25 | 0.55 |
| (11) | \|f3/f4\| | 1.017 | 0.7 | 1.3 |
| (12) | \|f4/f2\| | 0.009 | 0.01 | 0.15 |
| (13) | \|f3/f2\| | 0.010 | 0.01 | 0.17 |
| (14) | OAL/2*IH | 0.629 | 0.61 | 0.65 |
| (17) | f/f2 | 0.021 | 0.01 | 0.25 |

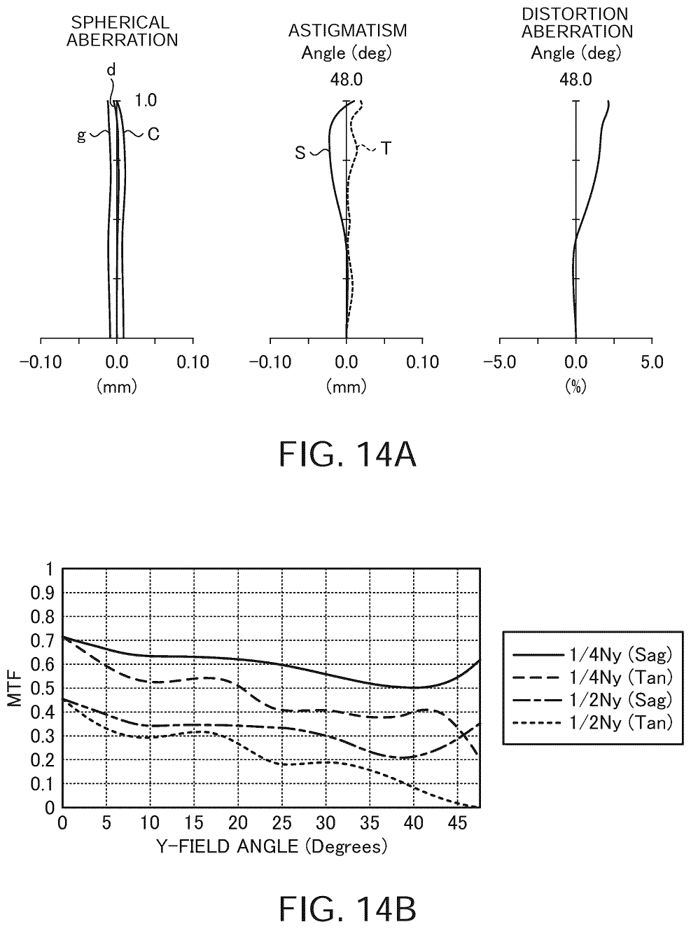

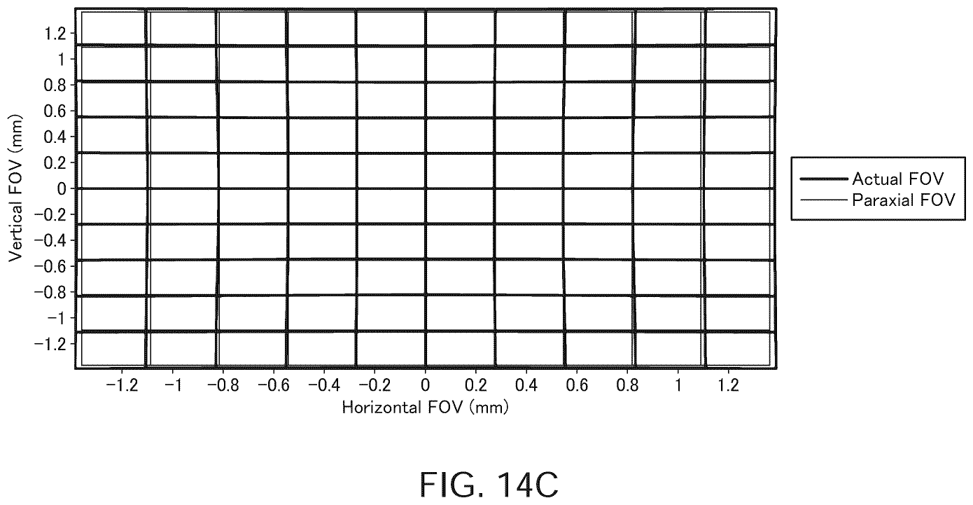

These aberration diagrams, MTFs, and distortion grids are illustrated in FIGS. 14A to 14C, and as is clear from each aberration diagram, the performance is good.

### Example 8

f=2.1 mm, FNo.=2.2, HFOV=47°

Table 29 illustrates the data from Example 8.

TABLE 29

| No | R | D | Nd | Vd | SD | f |
|---|---|---|---|---|---|---|
| 1 | — | −0.07 | | | 0.47 | |
| 2 | 1.172 | 0.295 | 1.5365 | 55.98 | 0.51 | 3.3 |
| 3 | 3.134 | 0.308 | | | 0.57 | |
| 4 | 4.079 | 0.214 | 1.6328 | 23.29 | 0.62 | 17.0 |
| 5 | 6.399 | 0.111 | | | 0.78 | |
| 6 | −1.861 | 0.749 | 1.5365 | 55.98 | 0.95 | 1.2 |
| 7 | −0.551 | 0.100 | | | 1.04 | |
| 8 | 3.647 | 0.375 | 1.6652 | 29.43 | 1.15 | −1.2 |
| 9 | 0.609 | 0.563 | | | 1.72 | |
| 10 | — | 0.11 | 1.52 | 64.20 | 2.12 | — |
| 11 | — | 0.144 | | | 2.16 | |
| 12 | — | — | | | | |

The aspherical data is illustrated below.

TABLE 30

| | 2 | 3 | 4 | 5 |
|---|---|---|---|---|
| Conic | −8.6995.E−01 | 2.4492.E+01 | −1.1377.E+01 | 1.9229.E+01 |
| constant(k) | | | | |
| 4th order | 6.8882.E−02 | −1.9440.E−01 | −4.3617.E−01 | −1.4439.E−01 |
| coefficients | | | | |
| 6th order | −2.8799.E−01 | −3.7255.E−01 | −7.5709.E−01 | −3.5126.E−01 |
| coefficients | | | | |
| 8th order | 1.4262.E+00 | −1.1404.E+00 | −3.4207.E−01 | −5.1456.E−02 |
| coefficients | | | | |
| 10th order | −4.1237.E+00 | −1.5080.E−01 | −4.6652.E−02 | 3.6418.E−01 |
| coefficients | | | | |
| 12th order | −4.4192.E+00 | 2.3541.E+00 | −5.5258.E+00 | 6.9224.E−01 |
| coefficients | | | | |
| 14th order | 8.5188.E+00 | −3.5003.E+01 | 1.1751.E+00 | −6.7589.E−02 |
| coefficients | | | | |
| 16th order | 0.0000.E+00 | 0.0000.E+00 | 0.0000.E+00 | 0.0000.E+00 |
| coefficients | | | | |
| | 6 | 7 | 8 | 9 |
| Conic | −6.4490.E+00 | −3.3202.E+00 | −1.9129.E+01 | −5.7927.E+00 |
| constant(k) | | | | |
| 4th order | 1.5463.E−01 | −2.6544.E−01 | −2.0912.E−01 | −1.8098.E−01 |
| coefficients | | | | |
| 6th order | 1.0445.E−01 | 8.6240.E−02 | −2.2852.E−01 | 8.2918.E−02 |
| coefficients | | | | |
| 8th order | 6.7948.E−03 | 7.7452.E−02 | 3.7002.E−01 | −2.4351.E−02 |
| coefficients | | | | |
| 10th order | −8.8796.E−02 | 7.4430.E−03 | −2.2643.E−01 | 3.3240.E−04 |
| coefficients | | | | |
| 12th order | −5.9428.E−02 | 2.7316.E−03 | 9.8169.E−03 | 5.6860.E−04 |
| coefficients | | | | |
| 14th order | 7.0763.E−02 | −9.8600.E−03 | 1.3390.E−02 | 1.4681.E−04 |
| coefficients | | | | |
| 16th order | 0.0000.E+00 | 0.0000.E+00 | −2.4443.E−03 | −5.1759.E−05 |
| coefficients | | | | |

The values of the parameters of each condition are as follows.

TABLE 31

| Item | Number |
|---|---|
| f | 2.09 |
| Fno | 2.2 |
| OAL | 2.90 |
| IH | 2.31 |
| EfD1 | 0.932 |
| Half FOV | 47.00 |
| EP | 0.00 |
| EXP | −1.78 |
| f1 | 3.30 |
| f2 | 17.0 |
| f3 | 1.21 |
| f4 | −1.15 |
| N1 | 1.5365 |
| N2 | 1.6328 |
| N3 | 1.5365 |
| N4 | 1.6652 |

TABLE 32

| | Conditional | | | |
|---|---|---|---|---|
| | expression | Number | Lower limit | Upper limit |
| (1) | f/f1 | 0.633 | 0.45 | 0.80 |
| (2) | \|f4/f1\| | 0.350 | 0.25 | 0.50 |
| (3) | N1 < N4 | Refer to | | |
| | | Table 31 | | |
| (4) | N1 | 1.5365 | 1.49 | 1.55 |
| (5) | N4 | 1.6652 | 1.63 | 1.67 |
| (6) | f/OAL | 0.720 | 0.60 | 0.75 |
| (7) | OAL/EfD1 | 3.110 | 2.9 | 3.6 |
| (8) | EXP/IH | −0.770 | −0.94 | −0.70 |
| (9) | \|f1/f2\| | 0.194 | 0.01 | 0.40 |
| (10) | f3/f1 | 0.367 | 0.25 | 0.55 |
| (11) | \|f3/f4\| | 1.049 | 0.7 | 1.3 |
| (12) | \|f4/f2\| | 0.068 | 0.01 | 0.15 |
| (13) | \|f3/f2\| | 0.071 | 0.01 | 0.17 |
| (14) | OAL/2*IH | 0.629 | 0.61 | 0.65 |
| (17) | f/f2 | 0.123 | 0.01 | 0.25 |

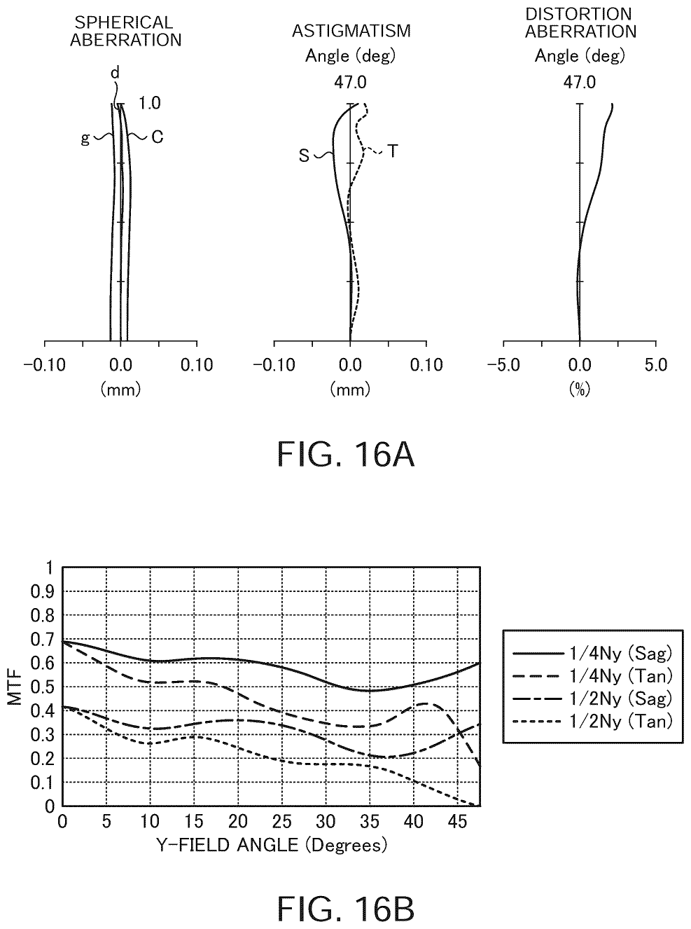

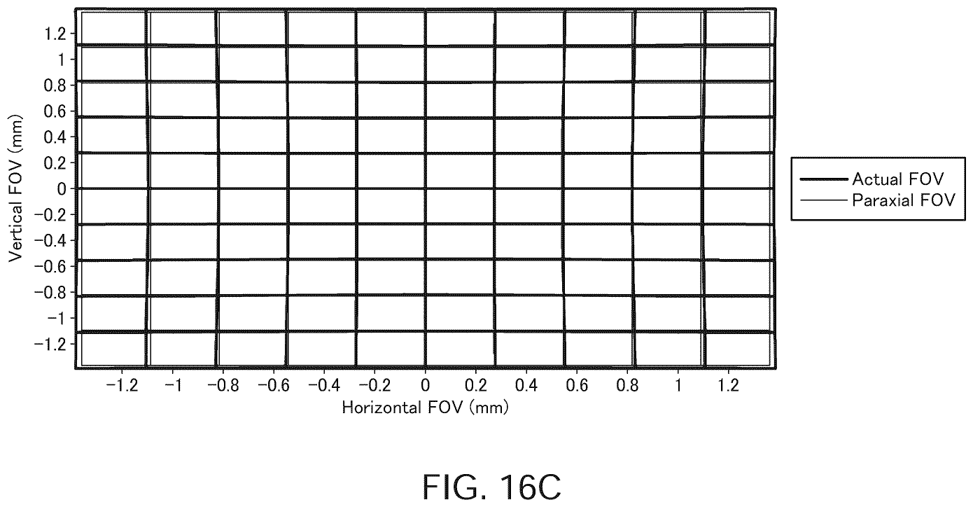

These aberration diagrams, MTFs, and distortion grids are illustrated in FIGS. 16A to 16C, and as is clear from each aberration diagram, the performance is good.

### Example 9

f=2.1 mm, FNo.=2.2, HFOV=46.5°

Table 33 illustrates the data from Example 9.

TABLE 33

| No | R | D | Nd | Vd | SD | f |
|---|---|---|---|---|---|---|
| 1 | — | −0.08 | | | 0.47 | |
| 2 | 1.143 | 0.297 | 1.5365 | 55.98 | 0.51 | 3.2 |
| 3 | 3.045 | 0.313 | | | 0.56 | |
| 4 | 4.639 | 0.209 | 1.6328 | 23.29 | 0.62 | 15.8 |
| 5 | 8.425 | 0.111 | | | 0.77 | |
| 6 | −1.834 | 0.753 | 1.5365 | 55.98 | 0.97 | 1.2 |
| 7 | −0.549 | 0.100 | | | 1.04 | |
| 8 | 5.998 | 0.388 | 1.6328 | 23.29 | 1.13 | −1.1 |
| 9 | 0.623 | 0.578 | | | 1.72 | |
| 10 | — | 0.11 | 1.52 | 64.20 | 2.12 | — |
| 11 | — | 0.123 | | | 2.16 | |
| 12 | — | — | | | | |

The aspherical data is illustrated below.

TABLE 34

| Surface number | 2 | 3 | 4 | 5 |
|---|---|---|---|---|
| Conic | −7.7662.E−01 | 2.3282.E+01 | −6.7333.E+00 | 4.4176.E+01 |
| constant(k) | | | | |
| 4th order | 7.5113.E−02 | −1.8742.E−01 | −4.2475.E−01 | −8.2250.E−02 |
| coefficients | | | | |
| 6th order | −2.8805.E−01 | −4.4425.E−01 | −8.9993.E−01 | −5.0047.E−01 |
| coefficients | | | | |
| 8th order | 1.3188.E+00 | −7.9043.E−01 | −6.1364.E−01 | −7.0624.E−02 |
| coefficients | | | | |
| 10th order | −3.2240.E+00 | −8.5216.E−01 | 7.8954.E−02 | 5.4839.E−01 |
| coefficients | | | | |
| 12th order | −4.4192.E+00 | 2.3541.E+00 | −5.5258.E+00 | 9.1117.E−01 |
| coefficients | | | | |
| 14th order | 4.9018.E+00 | −3.5003.E+01 | 1.1751.E+00 | −3.1763.E−01 |
| coefficients | | | | |
| 16th order | 0.0000.E+00 | 0.0000.E+00 | 0.0000.E+00 | 0.0000.E+00 |
| coefficients | | | | |
| Surface number | 6 | 7 | 8 | 9 |
| Conic | −6.1008.E+00 | −3.2849.E+00 | 8.9522.E+00 | −6.1426.E+00 |
| constant(k) | | | | |
| 4th order | 1.7557.E−01 | −2.7544.E−01 | −2.3480.E−01 | −1.7990.E−01 |
| coefficients | | | | |
| 6th order | 1.0571.E−01 | 5.8055.E−02 | −2.8093.E−01 | 7.9660.E−02 |
| coefficients | | | | |
| 8th order | −9.1363.E−03 | 1.0450.E−01 | 4.2638.E−01 | −2.2773.E−02 |
| coefficients | | | | |
| 10th order | −8.6347.E−02 | 3.4620.E−02 | −2.3115.E−01 | 7.3484.E−04 |
| coefficients | | | | |
| 12th order | −3.7533.E−02 | 6.8252.E−03 | −3.5486.E−03 | 4.0814.E−04 |
| coefficients | | | | |
| 14th order | 5.8012.E−02 | −2.4297.E−02 | 1.2051.E−02 | 7.4728.E−05 |
| coefficients | | | | |
| 16th order | 0.0000.E+00 | 0.0000.E+00 | −2.8872.E−03 | −3.1524.E−05 |
| coefficients | | | | |

The values of the parameters of each condition are as follows.

TABLE 35

| Item | Number |
|---|---|
| f | 2.12 |
| Fno | 2.2 |
| OAL | 2.90 |
| IH | 2.29 |
| EfD1 | 0.947 |
| Half FOV | 46.50 |
| EP | 0.000 |
| EXP | −1.77 |
| f1 | 3.22 |
| f2 | 15.8 |
| f3 | 1.21 |
| f4 | −1.12 |
| N1 | 1.5365 |
| N2 | 1.6328 |
| N3 | 1.5365 |
| N4 | 1.6328 |

TABLE 36

| | Conditional | | | |
|---|---|---|---|---|
| | expression | Number | Lower limit | Upper limit |
| (1) | f/f1F | 0.659 | 0.45 | 0.80 |
| (2) | \|f4/f1\| | 0.348 | 0.25 | 0.50 |
| (3) | N1 < N4 | Refer to | | |
| | | Table 34 | | |
| (4) | N1 | 1.5365 | 1.49 | 1.55 |
| (5) | N4 | 1.6328 | 1.63 | 1.67 |
| (6) | f/OAL | 0.732 | 0.60 | 0.75 |
| (7) | OAL/EfD1 | 3.062 | 2.9 | 3.6 |
| (8) | EXP/IH | −0.774 | −0.94 | −0.70 |
| (9) | \|f1/f2\| | 0.204 | 0.01 | 0.40 |
| (10) | f3/f1 | 0.375 | 0.25 | 0.55 |
| (11) | \|f3/f4\| | 1.078 | 0.7 | 1.3 |
| (12) | \|f4/f2\| | 0.071 | 0.01 | 0.15 |
| (13) | \|f3/f2\| | 0.076 | 0.01 | 0.17 |
| (14) | OAL/2*IH | 0.633 | 0.61 | 0.65 |
| (17) | f/f2 | 0.134 | 0.01 | 0.25 |

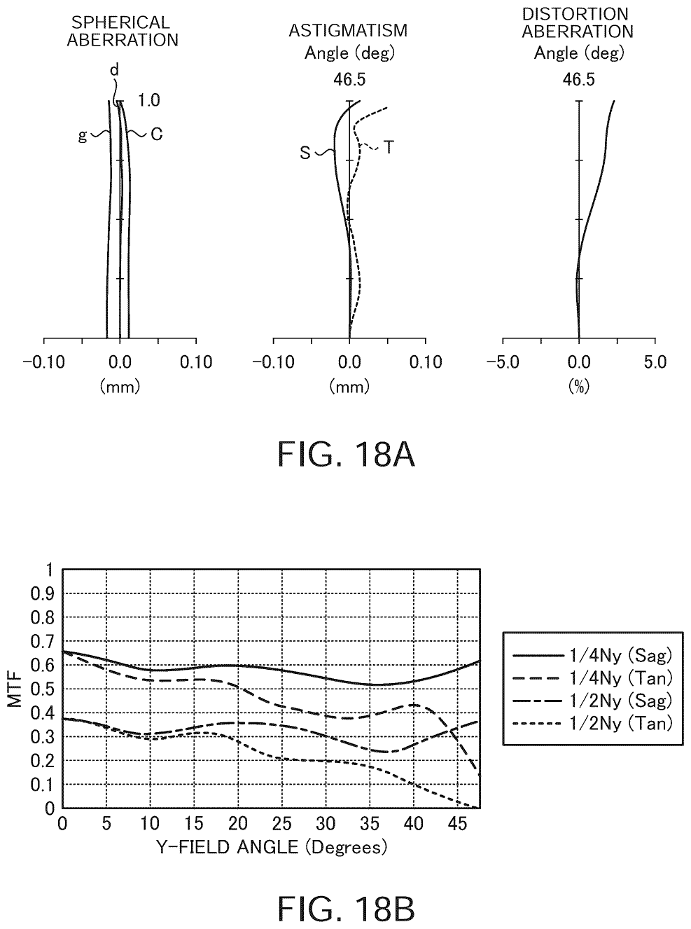

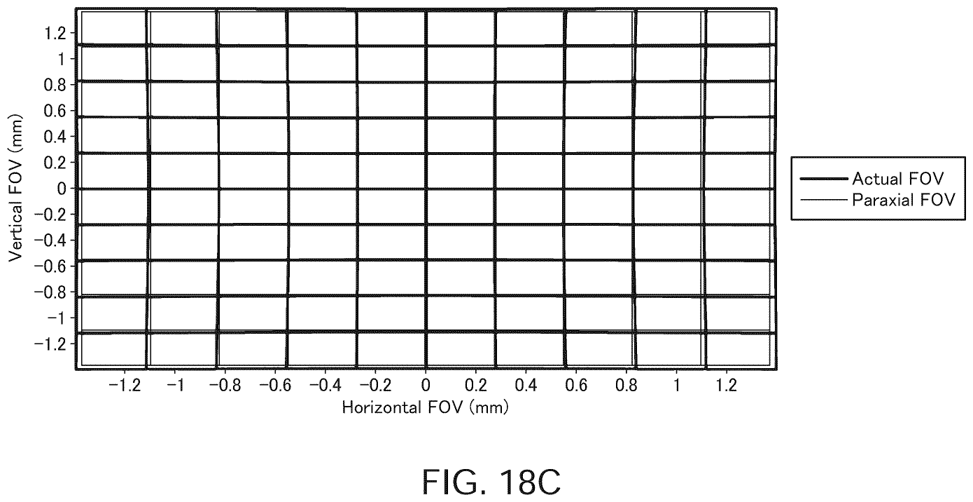

These aberration diagrams, MTFs, and distortion grids are illustrated in FIGS. 18A to 18C, and as is clear from each aberration diagram, the performance is good.

### Example 10

f=2.1 mm, FNo.=2.2, HFOV=46.5°

Table 37 illustrates the data from Example 10.

TABLE 37

| No | R | D | Nd | Vd | SD | f |
|---|---|---|---|---|---|---|
| 1 | — | −0.095 | | | 0.47 | |
| 2 | 1.120 | 0.275 | 1.5540 | 71.76 | 0.49 | 3.2 |
| 3 | 2.818 | 0.338 | | | 0.54 | |
| 4 | 4.478 | 0.201 | 1.6328 | 23.29 | 0.61 | 9.7 |
| 5 | 15.739 | 0.100 | | | 0.76 | |
| 6 | −1.631 | 0.722 | 1.5365 | 55.98 | 0.95 | 1.7 |
| 7 | −0.668 | 0.113 | | | 1.02 | |
| 8 | 5.368 | 0.520 | 1.6652 | 29.43 | 1.11 | −1.5 |
| 9 | 0.790 | 0.436 | | | 1.77 | |
| 10 | — | 0.11 | 1.52 | 64.20 | 2.10 | — |
| 11 | — | 0.18 | | | 2.14 | |
| 12 | — | — | | | | |

The aspherical data is illustrated below.

TABLE 38

| | 2 | 3 | 4 | 5 |
|---|---|---|---|---|
| Conic | −7.7662.E−01 | 2.3282.E+01 | −6.7333.E+00 | 4.4176.E+01 |
| constant(k) | | | | |
| 4th order | 7.5113.E−02 | −1.8742.E−01 | −4.2475.E−01 | −8.2250.E−02 |
| coefficients | | | | |
| 6th order | −2.8805.E−01 | −4.4425.E−01 | −8.9993.E−01 | −5.0047.E−01 |
| coefficients | | | | |
| 8th order | 1.3188.E+00 | −7.9043.E−01 | −6.1364.E−01 | −7.0624.E−02 |
| coefficients | | | | |
| 10th order | −3.2240.E+00 | −8.5216.E−01 | 7.8954.E−02 | 5.4839.E−01 |
| coefficients | | | | |
| 12th order | −4.4192.E+00 | 2.3541.E+00 | −5.5258.E+00 | 9.1117.E−01 |
| coefficients | | | | |
| 14th order | 4.9018.E+00 | −3.5003.E+01 | 1.1751.E+00 | −3.1763.E−01 |
| coefficients | | | | |
| 16th order | 0.0000.E+00 | 0.0000.E+00 | 0.0000.E+00 | 0.0000.E+00 |
| coefficients | | | | |
| | 6 | 7 | 8 | 9 |
| Conic | −6.1008.E+00 | −3.2849.E+00 | 8.9522.E+00 | −6.1426.E+00 |
| constant(k) | | | | |
| 4th order | 1.7557.E−01 | −2.7544.E−01 | −2.3480.E−01 | −1.7990.E−01 |
| coefficients | | | | |
| 6th order | 1.0571.E−01 | 5.8055.E−02 | −2.8093.E−01 | 7.9660.E−02 |
| coefficients | | | | |
| 8th order | −9.1363.E−03 | 1.0450.E−01 | 4.2638.E−01 | −2.2773.E−02 |
| coefficients | | | | |
| 10th order | −8.6347.E−02 | 3.4620.E−02 | −2.3115.E−01 | 7.3484.E−04 |
| coefficients | | | | |
| 12th order | −3.7533.E−02 | 6.8252.E−03 | −3.5486.E−03 | 4.0814.E−04 |
| coefficients | | | | |
| 14th order | 5.8012.E−02 | −2.4297.E−02 | 1.2051.E−02 | 7.4728.E−05 |
| coefficients | | | | |
| 16th order | 0.0000.E+00 | 0.0000.E+00 | −2.8872.E−03 | −3.1524.E−05 |
| coefficients | | | | |

The values of the parameters of each condition are as follows.

TABLE 39

| Item | Number |
|---|---|
| f | 2.12 |
| Fno | 2.2 |
| OAL | 2.90 |
| IH | 2.30 |
| EfD1 | 0.945 |
| Half FOV | 46.50 |
| EP | 0.00 |
| EXP | −1.62 |
| f1 | 3.16 |
| f2 | 9.73 |
| f3 | 1.66 |
| f4 | −1.46 |
| N1 | 1.5540 |
| N2 | 1.6328 |
| N3 | 1.5365 |
| N4 | 1.6652 |

TABLE 40

| | Conditional | | | |
|---|---|---|---|---|
| | expression | Number | Lower limit | Upper limit |
| (1) | f/f1 | 0.669 | 0.45 | 0.80 |
| (2) | \|f4/f1\| | 0.461 | 0.25 | 0.50 |
| (3) | N1 < N4 | Refer to | | |
| | | Table 38 | | |
| (4) | N1 | 1.5540 | 1.49 | 1.55 |
| (5) | N4 | 1.6652 | 1.63 | 1.67 |
| (6) | f/OAL | 0.730 | 0.60 | 0.75 |
| (7) | OAL/EfD1 | 3.069 | 2.9 | 3.6 |
| (8) | EXP/IH | −0.706 | −0.94 | −0.70 |
| (9) | \|f1/f2\| | 0.325 | 0.01 | 0.40 |
| (10) | f3/f1 | 0.526 | 0.25 | 0.55 |
| (11) | \|f3/f4\| | 1.141 | 0.7 | 1.3 |
| (12) | \|f4/f2\| | 0.150 | 0.01 | 0.15 |
| (13) | \|f3/f2\| | 0.171 | 0.01 | 0.17 |
| (14) | OAL/2*IH | 0.630 | 0.61 | 0.65 |
| (17) | f/f2 | 0.218 | 0.01 | 0.25 |

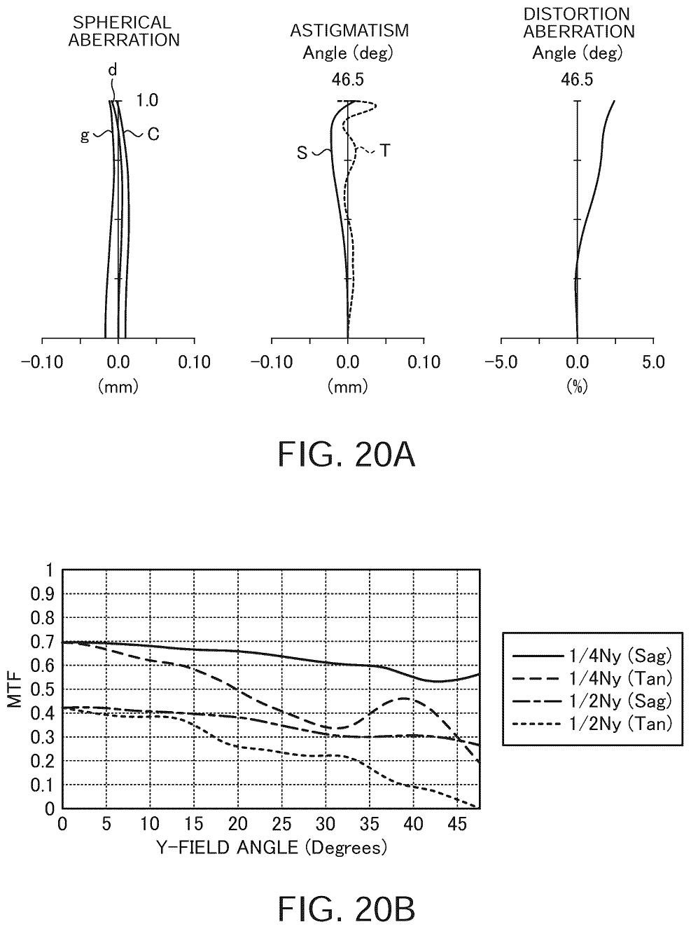

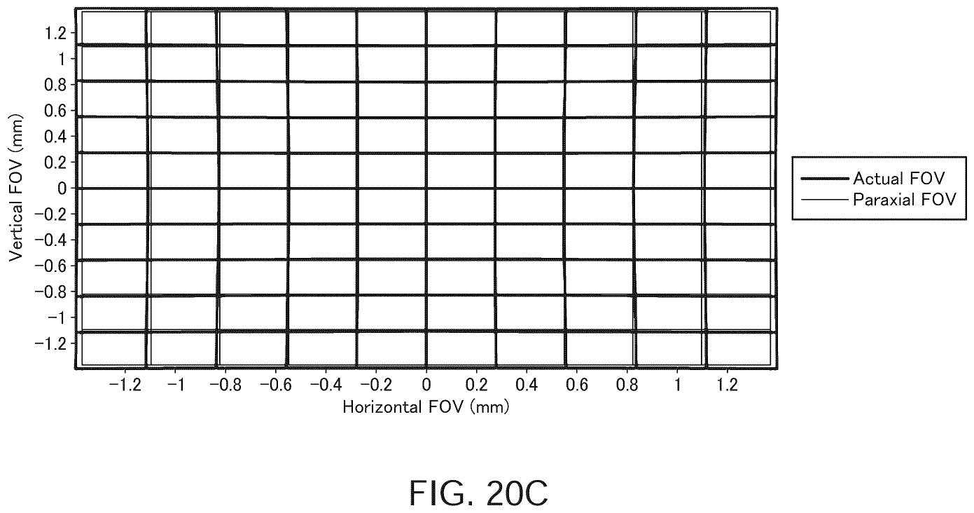

These aberration diagrams, MTFs, and distortion grids are illustrated in FIGS. 20A to 20C, and as is clear from each aberration diagram, the performance is good.

Hereinbefore, as illustrated in Examples 1 to 10, and FIGS. 2A to 2C, FIGS. 4A to 4C, FIGS. 6A to 6C, FIGS. 8A to 8C, FIGS. 10A to 10C, FIGS. 12A to 12C, FIGS. 14A to 14C, FIGS. 16A to 16C, FIGS. 18A to 18C, and FIGS. 20A to 20C, the imaging lens 100 of the present disclosure is bright, has high performance, and is miniaturized (shortening in the optical axis direction), realizing a half angle of view of approximately 50° with four lenses, and it is clear that the imaging lens 100 is suitable for use as an imaging device, particularly an imaging device for a laptop PC.

Hereinbefore, although several embodiments of the present application have been described in detail with reference to the drawings, these are merely examples. The present invention can be implemented in other embodiments with various modifications and improvements based on the knowledge of those skilled in the art, including the aspects described in the disclosure of the present invention.

### DESCRIPTION OF SYMBOLS

30 information processing apparatus
31 imaging device
100 imaging lens
L1 first lens
L2 second lens
L3 third lens
L4 fourth lens
S aperture stop
CG cover glass

What is claimed is:

1. An imaging lens, comprising:
a first lens, a second lens, a third lens, and a fourth lens disposed in order from an object side; and
an aperture stop on a foremost object side, wherein
the first lens is a positive meniscus lens having a convex surface facing the object side,
the second lens is a lens having an inflection point on at least one surface with a low thickness deviation ratio,
the third lens is a positive lens having a convex surface facing an image plane side and an inflection point on a lens peripheral portion,
the fourth lens is a negative lens having a concave surface on an image plane side and an inflection point on a peripheral portion, and
Conditions (1) and (2) are satisfied,
$$0.45 < \vert f / f 1 \vert < 0.8 and \qquad ( 1 )$$
$$0.25 < \vert f 4 / f 1 \vert < 0.5 , \qquad ( 2 )$$
when a focal length of the first lens is denoted by f1, a focal length of the fourth lens is denoted by f4, and a focal length of an entire optical system is denoted by f.

2. The imaging lens according to claim 1, wherein Condition (3) is satisfied,
$$N 1 < N 4 , \qquad ( 3 )$$
when a refractive index of a material of the first lens with respect to a d-line is denoted by N1 and a refractive index of a material of the fourth lens with respect to the d-line is denoted by N4.

3. The imaging lens according to claim 1, wherein Condition (4) is satisfied,
$$1.49 < N 1 < 1.55 , \qquad ( 4 )$$
when a refractive index of a material of the first lens with respect to a d-line is denoted by N1.

4. The imaging lens according to claim 1, wherein Condition (5) is satisfied,
$$1. 63 < N 4 < 1.67 , \qquad ( 5 )$$
when a refractive index of a material of the fourth lens with respect to a d-line is denoted by N4.

5. The imaging lens according to claim 1, wherein Condition (6) is satisfied,
$$0.6 < f / OAL < 0.75 , \qquad ( 6 )$$
when the focal length of the entire optical system is denoted by f and a total length of an optical system is denoted by OAL.

6. The imaging lens according to claim 1, wherein Condition (7) is satisfied,
$$2.9 < OAL / EfD 1 < 3.6 , \qquad ( 7 )$$
when an optical overall length is denoted by OAL and an optical effective diameter of a lens on the foremost object side is denoted by EfD1.

7. The imaging lens according to claim 1, wherein Condition (8) is satisfied,
$$- 0.94 < EXP / IH < - 0 \text{.70} , \qquad ( 8 )$$
when a position of an exit pupil is denoted by EXP and an image height is denoted by IH.

8. The imaging lens according to claim 1, wherein Condition (9) is satisfied,
$$0.01 < \vert f 1 / f 2 \vert < 0.4 , \qquad ( 9 )$$
when the focal length of the first lens is denoted by f1 and a focal length of the second lens is denoted by f2.

9. The imaging lens according to claim 1, wherein Condition (10) is satisfied,
$$0.2 5 < f 3 / f 1 < 0.55 , \qquad ( 10 )$$
when the focal length of the first lens is denoted by f1 and a focal length of the third lens is denoted by f3.

10. The imaging lens according to claim 1, wherein Condition (11) is satisfied,
$$0.7 < \vert D 3 / f 4 \vert < 1.3 , \qquad ( 11 )$$
when a focal length of the third lens is denoted by f3 and the focal length of the fourth lens is denoted by f4.

11. The imaging lens according to claim 1, wherein the second lens has a negative power, and Condition (16) is satisfied,
$$- 0.2 < f / f 2 < - 0. , \qquad ( 16 )$$
when a focal length of the second lens is denoted by f2 and the focal length of the entire optical system is denoted by f.

12. The imaging lens according to claim 1, wherein the second lens has a positive power, and Condition (17) is satisfied,
$$0. < f / f 2 < 0.25 , \qquad ( 17 )$$
when a focal length of the second lens is denoted by f2 and the focal length of the entire optical system is denoted by f.

13. An imaging device, comprising:
the imaging lens according to claim 1; and
a solid-state imaging element configured to receive an image formed by the imaging lens and generate an imaging signal.

14. An information processing apparatus, comprising:
the imaging device according to claim 13; and
a display unit configured to display an image corresponding to the imaging signal generated by the imaging device.
